(19) United States
(12) Patent Application Publication
(10) Pub. No.: US 2026/0329678 A1
(43) Pub. Date: Oct. 22, 2026

(54) SYSTEM

(71) Applicant: SoftBank Group Corp., Tokyo (JP)

(72) Inventor: Mai YAMAMOTO, Tokyo (JP)

(73) Assignee: SoftBank Group Corp., Tokyo (JP)

(21) Appl. No.: 19/649,184

(22) Filed: Apr. 16, 2026

(30) Foreign Application Priority Data
Apr. 21, 2025 (JP) 2025-069950

(51) Int. Cl. G06F 9/54; G06F 16/22; G06F 16/25; G06F 16/28

(52) U.S. Cl. CPC G06F 9/547; G06F 16/2237; G06F 16/258; G06F 16/285

(57) ABSTRACT

The present invention relates to a crisis management system that collects data in real time from diverse information sources such as internal and external news, SNS, weather information, market data, disaster information, and IoT sensors, performs extraction of risk factors, prediction of an occurrence probability and a degree of impact, generation of a composite risk scenario, and automatic determination of a risk level using generative AI, automatically plans an optimal countermeasure with reference to past cases, internal regulations, and external guidelines, automatically generates and distributes reports and alert notifications optimized for each related party, automatically executes an approved countermeasure plan in cooperation with a related system, and also includes progress monitoring and learning/evolution functions.

### CROSS-REFERENCE TO RELATED APPLICATION

The present application claims priority to and incorporates by reference the entire contents of Japanese Patent Application No. 2025-069950 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is to comprehensively and fundamentally solve a series of problems that threaten business continuity and social credibility of a company, such as overlooking truly important risk information due to information overload, delaying or making mistakes in initial response and decision-making when a risk occurs, delaying and making crisis response inefficient due to insufficient inter-departmental cooperation and inefficient information transmission, difficulty in advanced risk prediction and automatic planning and execution of optimal countermeasures fully utilizing a vast amount of data in a conventional crisis management system, and inability to realize information transmission optimized for each related party such as management and a department in charge and rapid countermeasure execution, in modern times when the environment surrounding corporate activities is rapidly becoming complex and diverse, and a vast amount of and diverse information such as internal and external news, SNS, weather information, market data, and disaster information is distributed in real time.

### SUMMARY OF THE INVENTION

The present invention solves the problem by providing a crisis management system comprising an information collection unit, a risk analysis unit, and a countermeasure planning and execution unit, wherein the information collection unit has a function of automatically acquiring data in real time from diverse information sources such as internal and external news, SNS, weather information, market data, and disaster information, and classifying and organizing the acquired data by attributes such as time series, occurrence area, related department, and degree of impact; the risk analysis unit has a function of analyzing a vast amount of data obtained from the information collection unit using generative AI by methods such as natural language processing, pattern recognition, comparison with past cases, and correlation analysis with external data, extracting risk factors, quantitatively predicting a probability of risk occurrence and a degree of impact, and automatically determining a risk level such as a major risk, a medium risk, and a minor risk according to a severity of the risk; and the countermeasure planning and execution unit has a function of automatically generating a plurality of optimal countermeasures according to the risk level while referring to past response cases, internal regulations, external best practices, and the like using generative AI based on a risk determination result by the risk analysis unit, automatically creating reports and alert notifications whose contents are optimized for each related party such as for management and for a department in charge, and further automatically executing specific countermeasures such as inventory adjustment, system switching, backup activation, and person-in-charge assignment in cooperation with a related internal system for an approved countermeasure plan, thereby being a means for comprehensively and fundamentally solving problems such as overlooking of risk information and response delay due to information overload, inefficiency of inter-departmental cooperation, and limitations of conventional systems.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

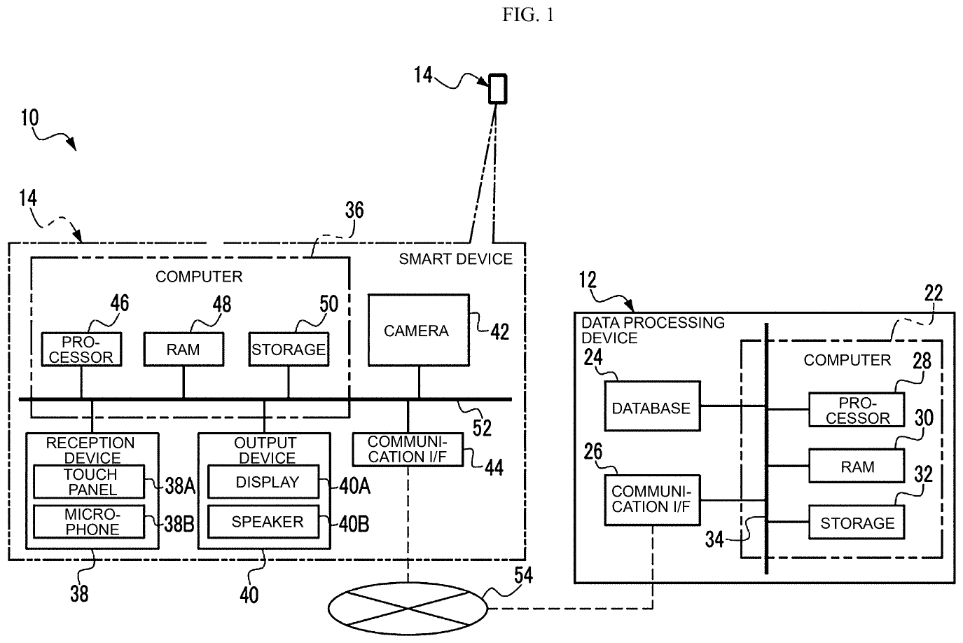

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

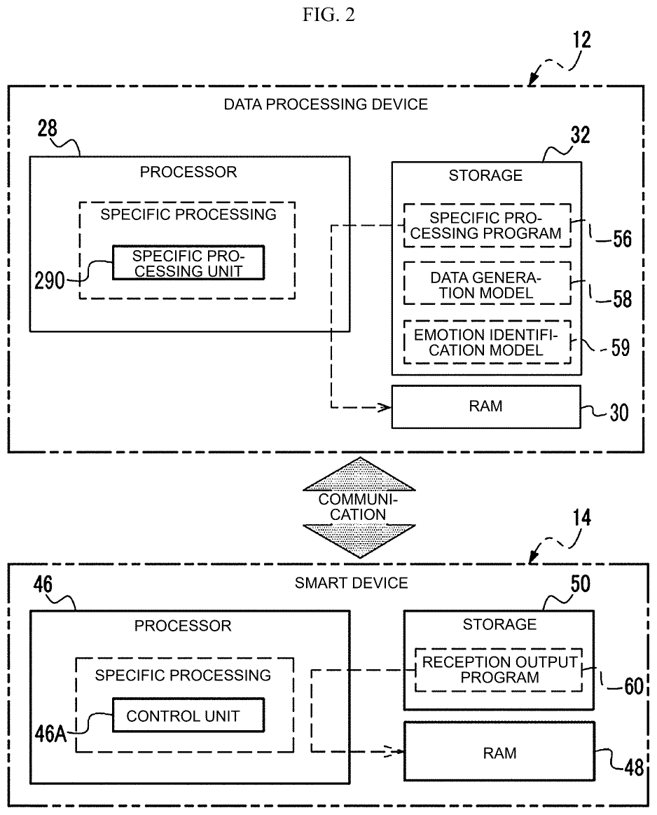

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

Embodiments of the present invention will be described more specifically and in detail. The crisis management system of the present invention is composed of a server and a terminal, and comprises an information collection unit, a risk analysis unit, and a countermeasure planning and execution unit. Hereinafter, comprehensive descriptions will be given from all perspectives, such as the configuration and function of each unit, the utilization method of generative AI, the role sharing between the server and the terminal, specific operation examples, expandability, security, user interfaces, external cooperation, and learning/evolution functions. Specifically, the present system is configured using a computing server group equipped with a plurality of processors, a large-capacity memory, and a high-speed communication interface. The present system deploys a large-scale neural network model equipped with an attention mechanism on the memory. The present system executes a vast amount of matrix operations at high speed by a parallel computing cluster using graphics processing units. Input data to the present system is a multidimensional numerical tensor. Elements of the input data include text embedding vectors and sensor time-series data. The present system executes preprocessing such as normalization and noise removal on the input data. As a specific example, the input data includes text data of news articles, temperature sensor data of a factory, image data of a surveillance camera, and the like. The present system integrates these input data and executes an inference process. Output data from the present system is an array of floating-point numbers indicating a probability of risk occurrence. Each value of the output data indicates a high possibility that a specific risk occurrence scenario will be realized. As a specific example, the output data includes numerical values such as an equipment failure probability of 0.95, a supply chain delay probability of 0.82, and a cyber attack probability of 0.15. The present system uses this output result for threshold determination in subsequent processing. The present system transmits an activation signal to a countermeasure planning module when the output value exceeds a preset threshold. The present system does not simply imitate human mental activities, but extracts minute correlations unrecognizable to humans through complex nonlinear operations in a high-dimensional vector space. Thereby, the present system exhibits technical effects of overwhelming acceleration of information processing and dramatic improvement of risk detection accuracy. This effect is brought about by a mechanism that maps multimodal data to a common latent space and analyzes it integrally. The present system is extremely useful in a specific application field of supply chain monitoring of a globally expanding manufacturing industry. Furthermore, the present system can also adopt a configuration in which a lightweight model is arranged in an edge computing environment as an alternative method.

First, the information collection unit is mainly realized on the server. The information collection unit automatically collects data from a very wide variety of information sources, such as internal and external news sites, SNS, the Meteorological Agency and disaster information providing organizations, financial market data vendors, EDI systems of business partners, inquiry management systems from customers, IoT sensor networks, surveillance camera systems, employee business report applications, open data APIs of local governments and public institutions, and alert distribution services of industry groups. For example, breaking news articles such as “bankruptcy of a major business partner”, “epidemic of a new infectious disease”, and “occurrence of a large-scale power outage” from news sites, posts such as “defect report of own product”, “disaster site photo by a local employee”, and “new service announcement by a competitor” from SNS, real-time data such as “typhoon course prediction”, “heavy rain warning”, and “lightning strike information” from weather information, indicators such as “sudden change in exchange rate”, “stock market crash”, and “soaring raw material prices” from market data, real-time data such as “abnormal vibration of factory equipment”, “rapid rise in warehouse temperature”, and “location information of logistics vehicle” from IoT sensors, image analysis results such as “intrusion of a suspicious person” and “smoke detection of fire occurrence” from surveillance cameras, and qualitative information such as “damage situation at the site” and “delivery delay contact from a supplier” from employee reports are acquired. These pieces of information are automatically collected by various means such as API cooperation, RSS feeds, email reception, file transfer, via chatbots, Web scraping, IoT gateways, and image recognition AI. Specifically, the present information collection unit executes a data collection process in multi-thread using an asynchronous communication protocol. The present information collection unit periodically performs a polling process on a communication interface of each information source. Input data to the present information collection unit is a text stream, a time-series numerical array, and an image tensor. Elements of the input data include a character code array, continuous values of floating-point numbers, and luminance values of pixels. The present information collection unit executes preprocessing such as unification of character codes and interpolation of missing values on the input data. As a specific example, the input data includes weather information text in JSON format, a numerical array of a vibration sensor sampled at intervals of 100 milliseconds, a surveillance camera image of full HD resolution, and the like. The present information collection unit temporarily stores these input data in a buffer area on the memory. Output data from the present information collection unit is structured data based on a unified data schema. Each value of the output data means a time stamp, an information source identifier, and a payload body. As a specific example, the output data includes a time stamp of Oct. 1, 2023, a sensor identification number 101, and a numerical value of a temperature of 35 degrees. The present information collection unit transfers this output result to a data preprocessing module in subsequent processing. The present information collection unit exhibits technical effects of efficient use of a network bandwidth and reduction of latency of data collection. This effect is brought about by a causal relationship of minimizing a waiting time of a processor by asynchronous input/output processing. The present information collection unit is indispensable in a specific application field of a wide-area disaster detection system in which real-time performance is extremely important. Furthermore, the present information collection unit can also adopt a publish-subscribe type messaging model as an alternative method.

The collected data is accumulated in a database on the server, and is automatically classified and tagged by various attributes such as time series, occurrence area, related department, degree of impact, reliability of information, information transmission source, data type (text, numerical value, image, audio, video, etc.), degree of urgency, related business area, business partner name, and customer name. For example, among SNS posts, those including “own company name+failure+local photo” are tagged as “failure risk”, “site”, and “high urgency”, and abnormal values of IoT sensors are classified as “equipment risk”, “factory”, and “immediate response required”. The information collection unit also automatically performs preprocessing such as deduplication of information, noise removal, reliability scoring, time-series correction of information, addition of geographic information, and automatic caption generation of image data. Specifically, the present data preprocessing unit efficiently stores a vast amount of data using a distributed vector database. The present data preprocessing unit executes a transformer-based neural network for natural language processing. Input data to the present neural network is an integer array of tokenized text. The number of dimensions of the input data is fixed to, for example, 512 dimensions. The present data preprocessing unit executes preprocessing such as stop word removal and stemming on the input data. As a specific example, the input data includes a complaint text from a customer, a body of a news article, a daily business report of an employee, and the like. The present neural network generates an embedding vector considering a context from the input data. Output data from the present neural network is a score array indicating a probability corresponding to each tag. Each value of the output data is a continuous value from zero to one, and means a degree of certainty belonging to a specific attribute. As a specific example, the output data includes numerical values such as a failure risk score of 0.9, a high urgency score of 0.85, and an equipment risk score of 0.1. The present data preprocessing unit uses this output result for metadata addition processing in subsequent processing. The present data preprocessing unit registers the corresponding tag as an index of the database when the output value exceeds a preset threshold of 0.8. The present data preprocessing unit exhibits technical effects of dramatic improvement of search speed and optimization of storage capacity. This effect is brought about by a high-speed clustering process using similarity calculation in a high-dimensional vector space. The present data preprocessing unit is extremely useful in a specific application field of constructing a large-scale incident management database. Furthermore, the present data preprocessing unit can also adopt a configuration in which rule-based regular expression matching is supplementarily combined as an alternative method.

The risk analysis unit is also mainly realized on the server. The risk analysis unit analyzes a vast amount of data obtained from the information collection unit from multiple angles using generative AI. First, using natural language processing (for example, a large language model) by generative AI, keywords, phrases, emotional expressions, causal relationships, time-series changes, intentions of related parties, and the like that become risk factors are extracted from unstructured text data such as news articles, SNS posts, internal reports, and customer inquiry contents. For example, all risk-related words such as “earthquake occurrence”, “tsunami warning”, “fire”, “failure”, “flaming”, “plunge”, “warning”, “deterioration”, “soaring”, “delivery delay”, “cyber attack”, “data leak”, “legal regulation change”, and “infectious disease spread” are automatically detected, and the type of risk, occurrence location, and impact range are estimated according to the context. Generative AI also performs sentiment analysis and topic modeling, and quantitatively evaluates signs of flaming on SNS, rising customer dissatisfaction, increasing employee anxiety, and the like. Specifically, the present risk analysis unit divides and loads a large language model having billions of parameters into a plurality of graphics processing units. The present risk analysis unit calculates a dependency relationship between words in a text using a self-attention mechanism. Input data to the present large language model is a token embedding vector of preprocessed text. The number of dimensions of the input data is, for example, 768 dimensions. The present risk analysis unit executes preprocessing of adding positional encoding to the input data. As a specific example, the input data includes a short post text of social media, a long economic news article, an internal failure report including technical terms, and the like. The present large language model executes a forward propagation operation based on the input data. Output data from the present large language model is a label array of named entity recognition and a sentiment score. Each value of the output data means a category identifier of the extracted risk factor and a numerical value indicating a polarity of sentiment. As a specific example, the output data includes an event label of fire, a location label of Tokyo, and a sentiment score of 0.92 indicating anger. The present risk analysis unit inputs this output result to a risk level determination module in subsequent processing. The present risk analysis unit writes a high risk flag in a shared area on the memory when the sentiment score exceeds a predetermined threshold. The present risk analysis unit exhibits technical effects of completely eliminating oversight by human visual inspection and overwhelmingly accelerating the analysis process. This effect is brought about by an attention mechanism that mathematically models long-term dependencies of context. The present risk analysis unit is extremely useful in a specific application field of early discovery of brand damage risk on social media. Furthermore, the present risk analysis unit can also adopt a configuration in which a small-scale model fine-tuned specifically for specific industry terms is operated in parallel as an alternative method.

In addition, using pattern recognition and time-series analysis by generative AI, abnormal values and rapid changes are detected from numerical data such as IoT sensor data and market data. For example, when vibration data of factory equipment deviates from a past normal range, when GPS data of a logistics vehicle deviates from a normal route, or when a stock price or an exchange rate fluctuates greatly in a short time, a risk signal is automatically generated by an abnormality detection algorithm. For image data, using an image recognition/object detection model by generative AI, smoke of a fire, intrusion of a suspicious person, a damage situation at a site, and the like are automatically discriminated from surveillance camera video. For audio data, using voice recognition and sentiment analysis by generative AI, the severity and urgency of a complaint are evaluated from call contents of a customer call center. Specifically, the present risk analysis unit executes a one-dimensional convolutional neural network for time-series analysis and a two-dimensional convolutional neural network for image recognition. Input data to the present time-series model is a multidimensional array consisting of sensor values of past 100 steps. The number of dimensions of the input data is, for example, a matrix of 100 rows and 6 columns. The present risk analysis unit executes preprocessing of smoothing using a moving average filter on the input data. As a specific example, the input data includes three-axis acceleration data of a motor, a fluctuation value per second of an exchange rate, latitude and longitude coordinates of a vehicle, and the like. The present time-series model predicts a numerical value of the next step from the input data. Output data from the present time-series model is a reconstruction error score between a predicted value and an actual observed value. Each value of the output data means a degree of deviation from a normal pattern. As a specific example, the output data includes a vibration abnormality score of 0.88, a route deviation score of 0.95, and the like. On the other hand, input data to the present image model is a three-channel color image tensor of 224 pixels square. Output data from the present image model is a coordinate array of a bounding box and a class probability. As a specific example, the output data includes a smoke detection probability of 0.97, a suspicious person detection probability of 0.89, and the like. The present risk analysis unit transmits these output results to an integrated alert generation module in subsequent processing. The present risk analysis unit issues an interrupt signal requesting an immediate response to a processor when the error score or the class probability exceeds a threshold. The present risk analysis unit exhibits a technical effect of integrated and real-time abnormality detection of multimodal data. This effect is brought about by a mechanism that projects different data formats into a common latent feature space and mathematically defines a complex abnormality. The present risk analysis unit is extremely useful in a specific application field of predictive maintenance and a crime prevention system in a smart factory. Furthermore, the present risk analysis unit can also adopt time-series prediction using a long short-term memory network as an alternative method.

Furthermore, generative AI performs correlation analysis by combining past risk occurrence cases or external databases (for example, cross-industry disaster databases, cyber attack incident collections, legal regulation revision histories, supply chain failure case collections, etc.) and currently acquired data, and quantitatively predicts a probability of risk occurrence and a degree of impact. For example, referring to a case where logistics in a specific area was disrupted when a typhoon approached in the past, a case where flaming on SNS directly led to a stock price plunge, a case where a system failure expanded in a chain reaction when a cyber attack occurred, and the like, a plurality of risk occurrence scenarios are generated by collating with the current situation. Generative AI automatically determines a risk level such as a major risk, a medium risk, and a minor risk according to a severity of the risk, prioritizes each type of risk, and also performs composite risk evaluation when a plurality of risks occur simultaneously. Specifically, the present risk analysis unit executes a graph neural network to model complex causal relationships. Input data to the present graph neural network is a node feature vector indicating a current situation and an edge connection matrix extracted from a past case database. Elements of the input data include an occurrence time of each event, geographic coordinates, and a relevance strength between events. The present risk analysis unit executes preprocessing of normalization of a graph structure and deletion of isolated nodes on the input data. As a specific example, the input data includes atmospheric pressure data of a current typhoon, damage scale data of a past logistics disruption case, and a similarity edge connecting them. The present graph neural network executes a message passing process of propagating a feature vector between adjacent nodes. Output data from the present graph neural network is an array of an occurrence probability and an impact degree score of each risk scenario. Each value of the output data is a probability value from zero to one and an integer value from one to ten, and means a future damage scale. As a specific example, the output data includes a logistics disruption probability of 0.85, an impact degree score of 9, a system failure chain probability of 0.72, an impact degree score of 8, and the like. The present risk analysis unit uses this output result for calculation of a comprehensive risk score in subsequent processing. The present risk analysis unit calculates a product of the occurrence probability and the impact degree score, and sorts the risk scenarios in descending order based on the result. The present risk analysis unit exhibits a technical effect of predicting a chain risk, which is difficult to predict from a single event, with high accuracy. This effect is brought about by a learning mechanism of nonlinear relationships in a high-dimensional graph space. The present risk analysis unit is extremely useful in a specific application field of impact simulation at the time of a complex disaster in a global supply chain. Furthermore, the present risk analysis unit can also adopt probabilistic inference using a Bayesian network as an alternative method.

The countermeasure planning and execution unit is mainly realized on the server, but also has some functions on the terminal side. Based on a risk determination result by the risk analysis unit, the countermeasure planning and execution unit automatically generates a plurality of optimal countermeasures according to a risk level and a type of risk while referring to past response cases, internal regulations, external best practices, industry guidelines, laws and regulations, contract conditions, agreements with customers, contract conditions with business partners, and the like using generative AI. For example, specific action plans are automatically generated, such as “securing employee safety”, “emergency stop of equipment”, “reconstruction of supply chain”, “notification of impact to customers”, “securing evacuation route”, “investigation of damage situation at local base”, and “cooperation with local government” for earthquake risk, “system blocking”, “backup activation”, “contact to related department”, “preparation for legal response”, “contact to external expert”, and “temporary blocking of customer information” for cyber attack risk, and “official statement announcement by public relations department”, “strengthening of SNS monitoring”, “expansion of customer response counter”, “immediate update of FAQ”, “automatic generation of apology text”, and “identification of impact range” for flaming risk. Generative AI automatically creates reports and alert notifications whose contents are optimized for each related party such as for management, for a department in charge, for an on-site person in charge, for a business partner, and for a customer, and rapidly distributes them through a management screen on the terminal side, a mobile terminal, an email, a chat system, a voice call, a push notification, and the like. For example, a report summarizing an overall picture of the risk and key points necessary for decision-making is provided to the management, specific work instructions and an emergency contact list are provided to the on-site person in charge, a dashboard visualizing overall progress and response status in real time is provided to the crisis management department, and a notification text briefly summarizing an impact range and a response policy is provided to the customer. Specifically, the present countermeasure planning unit executes a large language model incorporating a retrieval-augmented generation technology. Input data to the present language model is a comprehensive risk score output from the risk analysis unit, a risk type vector, and a context text of internal regulations retrieved from a vector database. The number of dimensions of the input data is a long sequence extending to thousands of tokens. The present countermeasure planning unit executes preprocessing of embedding into a prompt template on the input data. As a specific example, the input data includes risk information of occurrence of an earthquake with a seismic intensity of 6 upper, and a text of a manual defining an emergency stop procedure of a factory. The present language model generates a text by an autoregressive decoding process. Output data from the present language model is a text sequence for each step of the countermeasure, and an execution priority score of each step. Each value of the output data means a specific action content and an indicator of whether or not the action should be executed immediately. As a specific example, the output data includes a text of network blocking of a main server and a priority score of 1, and a text of first report transmission to a customer and a priority score of 2, and the like. The present countermeasure planning unit uses this output result for filtering processing according to an authority level of a related party in subsequent processing. The present countermeasure planning unit converts the generated text sequence into structured data in JSON format, and transmits it to a display module of each terminal. The present countermeasure planning unit exhibits a technical effect of instantaneously generating a dynamic and optimal resource allocation plan according to a situation. This effect is brought about by an attention mechanism that combines a vast past knowledge base and a current context in a latent space. The present countermeasure planning unit is extremely useful in a specific application field of incident response automation when a large-scale cyber attack occurs. Furthermore, the present countermeasure planning unit can also adopt a policy gradient method that maximizes a success probability of a countermeasure using reinforcement learning as an alternative method.

Furthermore, the countermeasure planning and execution unit automatically executes a countermeasure in cooperation with a related internal system for an approved countermeasure plan. For example, inventory adjustment according to a disaster risk is automatically implemented in cooperation with an inventory management system, system switching and backup activation are automated in cooperation with a system of an information system department, a person-in-charge assignment is automatically performed in cooperation with an employee management system, a delivery route is automatically changed in cooperation with a logistics system, and simultaneous notification to affected customers is automated in cooperation with a customer management system. Generative AI also performs effect verification and automatic monitoring of progress status after execution of the countermeasure, and automatically generates an additional countermeasure again as necessary. For example, when a new risk occurs after an initial response, or when a response is delayed, generative AI re-evaluates the situation and automatically notifies related parties of an additional instruction or warning. Specifically, the present execution management unit automatically issues a control command to each external system via an application programming interface gateway. Input data to the present execution management unit is structured data of an approved countermeasure plan. Elements of the input data include a system identifier of an execution target, a function name to be called, and a parameter group serving as an argument. The present execution management unit executes preprocessing of conversion of a data format and addition of an authentication token on the input data. As a specific example, the input data includes an identifier of an inventory management system, an inventory movement command, and a parameter of a movement quantity of 1,000 pieces. The present execution management unit asynchronously transmits these commands via a network interface. Output data received by the present execution management unit is an execution completion status code and execution log data from each system. Each value of the output data means an integer value indicating whether or not the command has been normally processed and a detailed history of the processing. As a specific example, the output data includes a status code of 200 indicating normal termination, and a time stamp indicating a processing completion time. The present execution management unit uses this output result for writing to a time-series database for progress monitoring in subsequent processing. The present execution management unit automatically schedules a retry process using an exponential backoff algorithm when the status code indicates an error. The present execution management unit exhibits technical effects of dramatic shortening of response time and complete elimination of human error by inter-system cooperation without human intervention. This effect is brought about by a causal relationship of state consistency guarantee by a distributed transaction management mechanism. The present execution management unit is extremely useful in a specific application field of dynamic routing of a logistics network and automatic relocation of inventory at the time of a natural disaster. Furthermore, the present execution management unit can also adopt a lower-latency communication protocol using a remote procedure call as an alternative method.

On the server side, heavy processing such as main processing of the information collection unit, the risk analysis unit, and the countermeasure planning and execution unit, large-scale data analysis by generative AI, scenario generation, automatic countermeasure planning, automatic report generation, internal system cooperation, progress monitoring, history management, access right management, security monitoring, and log management is centrally executed. On the terminal side, functions necessary for user interfaces and on-site responses are provided, such as dashboard display for each related party, reception of alert notifications, input of situation reports and response statuses by an on-site person in charge, decision-making and approval operations by management, confirmation of emergency response instructions at a site, voice input and image upload, automatic analysis of on-site photos, automatic transcription of on-site voices, and transmission of feedback from a site. For example, an on-site person in charge reports a damage situation with a photo from a mobile terminal, or management presses an approval button of a countermeasure plan on a terminal, whereby an automatic execution process on the server side is started. Specifically, the present system adopts a distributed architecture in which roles of edge computing and cloud computing are clearly separated. The present server-side system executes high-load tensor operations by batch processing and stream processing by a parallel computing cluster using graphics processing units. On the other hand, the present terminal-side system deploys an optimized lightweight inference model on a mobile processor. Input data to the present terminal-side model is raw image data from a camera sensor or raw audio waveform data from a microphone. The number of dimensions of the input data is a one-dimensional array of millions of pixels or tens of thousands of samples. The present terminal-side system executes preprocessing such as downsampling and noise canceling on the input data. As a specific example, the input data includes a high-resolution image photographing rubble at a disaster site, and a voice report of an on-site worker including surrounding noise. The present terminal-side model extracts a feature amount from these input data. Output data from the present terminal-side model is compressed vector data after feature amount extraction and an initial determination label. Each value of the output data means a low-dimensional numerical array expressing an essential feature of the data. As a specific example, the output data includes a 256-dimensional image feature vector and a text label of fire occurrence. The present terminal-side system uses this output result as a transmission payload to the server in subsequent processing. The present terminal-side system transmits the compressed vector data to the server via a secure communication channel, and significantly reduces a load on the server side. The present system exhibits technical effects of saving a communication bandwidth and distributing a calculation load on the server side. This effect is brought about by a causal relationship of minimizing a network transfer amount by data compression and initial inference on the edge side. The present system is extremely useful in a specific application field of efficient situation reporting from a disaster site where a communication infrastructure is unstable. Furthermore, the present system can also adopt a configuration in which federated learning is performed on the terminal side to update a model while protecting privacy as an alternative method.

The utilization of generative AI is the core of the present invention, and generative AI is indispensable in all aspects of the entire system, such as risk factor extraction by natural language processing, abnormality detection by pattern recognition, risk prediction by comparison with past cases, presentation of a plurality of risk patterns by scenario generation, automatic countermeasure planning, automatic generation of reports and notification texts, automatic monitoring and re-evaluation of progress status, automatic analysis of feedback from a site, automatic response to inquiries from users, automatic analysis of audio, image, and video data, automatic cooperation with an external database, and automatic learning of new internal and external risk patterns. For example, when a sign of flaming on SNS is detected, generative AI analyzes post contents, predicts a degree of impact by comparing with past flaming cases, automatically generates an optimal public relations countermeasure, and immediately notifies a public relations department and management. For example, when a typhoon approach is detected from weather information, generative AI collates past typhoon damage data and a current inventory status, and automatically generates an instruction for inventory movement and delivery route change to a logistics department. For example, when a sudden exchange rate fluctuation is detected from market data, generative AI refers to countermeasures at the time of past exchange rate fluctuations, and automatically generates a proposal for a hedge transaction and fund movement to a finance department. For example, when abnormal vibration of factory equipment is detected from an IoT sensor, generative AI compares it with past equipment failure data, and automatically generates an instruction for emergency inspection and preventive maintenance to a maintenance department. Specifically, the present system introduces a multi-agent artificial intelligence architecture that supervises the whole. The present system links sub-models specialized for each task, such as a language model, a visual model, and a time-series model, via a shared latent vector space. Input data to the present integrated model is a feature vector group output from each sub-model. Elements of the input data include a context vector of text, a spatial feature vector of an image, and a trend vector of a numerical value. The present system executes preprocessing of vector concatenation and dimensionality reduction on the input data. As a specific example, the input data includes an anger sentiment vector of an SNS post, a course prediction vector of a typhoon, and a vibration abnormality vector of a factory. The present integrated model integrates these input data and infers an optimal action policy as the entire system. Output data from the present integrated model is an integrated control vector that maximizes an action value function. Each value of the output data means a weighting score of a command to be issued to each department. As a specific example, the output data includes a notification score to a public relations department of 0.9, a route change score to a logistics department of 0.85, and the like. The present system inputs this output result to a decoder network in subsequent processing. The present system converts the integrated control vector into a specific control command or a natural language text message, and transmits it to a terminal of each department. The present system exhibits a technical effect of realizing broad and optimal decision-making by integrating siloed information. This effect is brought about by a cross-attention mechanism that learns correlations across a plurality of modalities. The present system is extremely useful in a specific application field of company-wide integrated risk management in a multinational corporation. Furthermore, the present system can also adopt a distributed multi-agent system in which each agent independently performs reinforcement learning as an alternative method.

Furthermore, in terms of security, communication between the server and the terminal is encrypted, and access authority is strictly managed for each user. The generative AI also automatically analyzes access logs and operation histories, and when detecting signs of unauthorized access or internal fraud, immediately transmits an alert to a system administrator. The system is capable of multilingual support and can be used even at overseas bases and multinational corporations. The user interface can be flexibly customized according to the type of terminal (PC, smartphone, tablet, wearable device, etc.) and the role of the user (management, on-site person in charge, crisis management department, public relations department, IT department, customer, business partner, etc.). Specifically, the security management unit encrypts all communication paths using a transport layer security protocol, and constructs a stateless authentication infrastructure using a JSON web token. The security management unit executes a recurrent neural network for user behavior detection. Input data to the neural network is a time-series vector indicating a user's operation history. Elements of the input data include a login time, an internet protocol address, an accessed resource identifier, and an encoded value of an operation content. The security management unit executes preprocessing of sequencing and normalization for each session on the input data. As a specific example, the input data includes an access record at 2:00 a.m., a connection from an unknown overseas IP address, and a history of issuing a large number of queries to a confidential database. The neural network calculates a degree of deviation of the current input data from a past normal behavior pattern. Output data from the neural network is an anomaly score indicating a divergence from normal behavior. Each value of the output data is a continuous value from zero to one, and means a probability of unauthorized access. As a specific example, the output data includes numerical values such as an account hijacking probability of 0.95 and an internal information taking-out probability of 0.88. The security management unit transmits this output result to an access control module in subsequent processing. When the anomaly score exceeds 0.8, which is a preset threshold value, the security management unit forcibly disconnects the corresponding session and immediately transmits a warning notification to the administrator's terminal. The security management unit exhibits technical effects of realizing a zero-trust architecture and blocking internal threats in real time. This effect is brought about by an abnormality detection mechanism based on learning of dynamic time-series patterns, rather than a static rule base. The system is extremely useful in a specific application field of providing a secure remote work environment in a financial institution handling confidential information. Furthermore, the system can also adopt multimodal authentication combined with biometric authentication data as an alternative method.

In addition, the system is equipped with a self-learning and evolution function, and the generative AI continuously learns new risk patterns and countermeasures to improve the accuracy and response capability of the entire system. For example, even for a new type of cyber attack responded to in the past, an unprecedented natural disaster, a new establishment of laws and regulations, and the like, the generative AI automatically expands a knowledge base and reflects it in risk prediction and countermeasure planning from the next time onward. Cooperation with external systems is also flexible, and real-time information exchange with a crisis management system of another company, a cross-industry information sharing platform, a disaster prevention system of a local government, a supply chain management system of a business partner, a CRM system of a customer, and the like is possible by API cooperation. Specifically, the learning and evolution unit implements a mechanism of online learning and continuous fine-tuning. The learning and evolution unit periodically inputs new data collected during system operation into a learning pipeline. Input data to the learning model is response history data of a newly occurred incident and a correct label indicating a result thereof. Elements of the input data include a feature vector of an event, a sequence of executed countermeasures, and a binary value indicating success or failure of the response. The learning and evolution unit executes preprocessing of data augmentation and creation of a mini-batch on the input data. As a specific example, the input data includes an attack log by unknown malware, a network blocking command executed in response thereto, and a correct label of success in preventing damage expansion. The learning and evolution unit uses a cross-entropy error as a loss function and optimizes weight parameters of the neural network by a gradient descent method. Output data from the learning and evolution unit is a set of an updated weight matrix and bias vector. Each value of the output data means a connection strength of the network reflecting new knowledge. As a specific example, the output data includes a parameter file consisting of hundreds of millions of floating-point numbers. The learning and evolution unit uses this output result for dynamic deployment to an inference model in a production environment in subsequent processing. The learning and evolution unit seamlessly updates the parameters of the model in the background without causing system downtime. The system exhibits technical effects of improving the adaptability of the system to environmental changes and preventing obsolescence of the model. This effect is brought about by a causal relationship of parameter optimization by continuous backpropagation of errors using actual operation data. The system is extremely useful in a specific application field of an adaptive cybersecurity system against malware that evolves daily. Furthermore, the system can also adopt a catastrophic forgetting prevention algorithm that learns new data while retaining important past data as an alternative method.

In this way, the crisis management system of the present invention is designed with depth from all perspectives, such as cooperation between the server and the terminal, omnidirectional utilization of generative AI, real-time data collection from diverse information sources, automation of risk analysis, prediction, countermeasure planning, execution, monitoring, and learning, optimal communication among related parties, external cooperation, security, expandability, and flexibility of the user interface, and dramatically improves the risk management level of a company in the modern age of information overload. Specifically, the system constructs the entire system using a microservices architecture and container orchestration technology. The system deploys each function such as information collection, risk analysis, and countermeasure planning as an independent container. Input data to the system is metrics data indicating a load status of the entire system. Elements of the input data include a processor usage rate, a memory consumption amount, and a network traffic amount of each container. The system executes preprocessing of calculating a moving average on the input data. As a specific example, the input data includes a processor usage rate of 90% for the risk analysis container, a memory consumption amount of 8 gigabytes for the information collection container, and the like. The system determines dynamic allocation of resources based on these input data. Output data from the system is a scaling command specifying the number of replicas of each microservice. Each value of the output data means the number of instances of the container to be activated. As a specific example, the output data includes a command to increase the number of replicas of the risk analysis container from 5 to 10. The system transmits this output result to a control interface of a virtualization infrastructure in subsequent processing. When detecting a rapid increase in traffic, the system activates a new container in milliseconds and automatically updates settings of a load balancer. The system exhibits technical effects of improving the availability of the entire system, eliminating a single point of failure, and preventing processing delays during a rapid increase in traffic. This effect is brought about by an architectural characteristic that each module is designed to be loosely coupled and can be scaled out independently. The system is extremely useful in a specific application field of a robust social infrastructure management system capable of withstanding access concentration when a large-scale disaster occurs. Furthermore, the system can also adopt a configuration that completely abstracts infrastructure management using a serverless computing environment as an alternative method.

### System Configuration

The system according to the present embodiment comprises an information collection unit, a data preprocessing unit, a risk analysis unit, a countermeasure planning unit, an execution management unit, a progress monitoring unit, a user interface unit, an external cooperation unit, a learning and evolution unit, and a security management unit. The information collection unit has a function of automatically acquiring data in real time from diverse information sources such as internal and external news sites, SNS, weather information providing organizations, market data vendors, electronic data interchange systems of business partners, customer inquiry management systems, IoT sensor networks, surveillance camera systems, employee business report applications, open data APIs of local governments and public institutions, and alert distribution services of industry groups. For example, the information collection unit acquires breaking news articles such as “bankruptcy of a major business partner” and “epidemic of a new infectious disease” from news sites, collects posts such as “defect report of own product” and “disaster site photo from a local employee” from SNS, acquires real-time data such as “typhoon course prediction” and “heavy rain warning” from weather information, and collects data such as “abnormal vibration of factory equipment” and “rapid rise in warehouse temperature” from IoT sensors. Furthermore, the information collection unit acquires image analysis results such as “intrusion of a suspicious person” and “smoke detection of fire occurrence” from surveillance cameras, and acquires qualitative information such as “damage situation at the site” and “delivery delay notification from a supplier” from employee reports. Specifically, the information collection unit realizes asynchronous communication between modules using a message queuing system. The information collection unit executes concurrent data fetching by multi-processing. Input data to the information collection unit is an endpoint and an authentication token of an application programming interface of each data source. Elements of the input data include a character string of a uniform resource locator and an encrypted access key. The information collection unit executes preprocessing of setting a connection timeout and defining the number of retries on the input data. As a specific example, the input data includes an address for acquiring open data of the Meteorological Agency, and connection credentials to an electronic data interchange system of a business partner. The information collection unit opens a network socket and transmits a request via a hypertext transfer protocol. Output data from the information collection unit is a byte stream and a timestamp of the acquired raw data. Each value of the output data means unprocessed binary data and an accurate time of data acquisition. As a specific example, the output data includes a byte array of a compressed JSON file, and a UNIX timestamp with millisecond precision. The information collection unit transfers this output result to an input buffer of the data preprocessing unit in subsequent processing. The information collection unit exhibits a technical effect of maximizing throughput by hiding input/output waiting time. This effect is brought about by a mechanism of avoiding processor blocking by an event-driven asynchronous input/output architecture. The system is extremely useful in a specific application field of a market data collection system in milliseconds in a financial institution. Furthermore, the system can also adopt bidirectional always-on streaming using a WebSocket as an alternative method.

The data preprocessing unit automatically classifies and tags the data obtained from the information collection unit by attributes such as time series, occurrence area, related department, degree of impact, reliability of information, information transmission source, data type, degree of urgency, related business area, business partner name, and customer name, and performs preprocessing such as deduplication, noise removal, reliability scoring, time-series correction of information, addition of geographic information, and automatic caption generation of image data. For example, among SNS posts, those including “own company name+failure+local photo” are tagged as “failure risk”, “site”, and “high urgency”, abnormal values of IoT sensors are classified as “equipment risk”, “factory”, and “immediate response required”, the reliability of news articles is scored from the transmission source and past results, and automatic captions are added to surveillance camera images. Specifically, the data preprocessing unit constructs a pipeline that executes a natural language processing model and an image captioning model in parallel. Input data to the data preprocessing unit is raw character string data including noise and a raw image tensor from a surveillance camera. Elements of the input data include text including special characters and HTML tags, and a pixel array including compression noise. The data preprocessing unit executes preprocessing of deleting unnecessary characters using a regular expression and resizing an image by bilinear interpolation on the input data. As a specific example, the input data includes a social media post text in which emojis and hashtags are frequently used, and a low-illuminance surveillance camera image taken at night. The data preprocessing unit inputs these input data into respective dedicated neural networks. Output data from the data preprocessing unit is an array of normalized word vectors and a text string describing features of the image. Each value of the output data means a coordinate value in a semantic space and a situation description in natural language. As a specific example, the output data includes a 768-dimensional text embedding vector, and a caption character string indicating that white smoke is generated in the factory. The data preprocessing unit uses this output result for conversion into a common JSON format in subsequent processing. The data preprocessing unit integrates feature amounts obtained from the text and the image, and transmits them to the risk analysis unit. The data preprocessing unit exhibits technical effects of improving inference accuracy of an artificial intelligence model in a subsequent stage and reducing a calculation load. This effect is brought about by a mechanism of performing dimensionality reduction of input data and extraction of semantic features in advance. The data preprocessing unit is extremely useful in a specific application field of data cleansing in an integrated monitoring center where data of diverse formats are mixed. Furthermore, the data preprocessing unit can also adopt a configuration in which a voice recognition model for extracting text from voice data is added to the pipeline as an alternative method.

The risk analysis unit analyzes a vast amount of data obtained from the data preprocessing unit from multiple angles using generative AI. The generative AI extracts keywords, phrases, emotional expressions, causal relationships, time-series changes, intentions of related parties, and the like that become risk factors from unstructured text data such as news articles, SNS posts, internal reports, and customer inquiry contents by natural language processing. For example, the generative AI automatically detects risk-related words such as “earthquake occurrence”, “tsunami warning”, “fire”, “failure”, “flaming”, “plunge”, “warning”, “deterioration”, “soaring”, “delivery delay”, “cyber attack”, “data leak”, “legal regulation change”, and “infectious disease spread”, and estimates the type of risk, occurrence location, and impact range according to the context. The generative AI also performs sentiment analysis and topic modeling, and quantitatively evaluates signs of flaming on SNS, an increase in customer dissatisfaction, an increase in employee anxiety, and the like. Furthermore, using pattern recognition and time-series analysis, the generative AI detects abnormal values and rapid changes from numerical data such as IoT sensor data and market data, and automatically generates a risk signal by an abnormality detection algorithm, for example, when vibration data of factory equipment deviates from a past normal range, or when a stock price or an exchange rate fluctuates greatly in a short time. For image data, the generative AI automatically discriminates smoke of a fire, intrusion of a suspicious person, a damage situation at a site, and the like from surveillance camera video using image recognition AI, and for voice data, evaluates the severity and urgency of a complaint from call contents of a customer call center using voice recognition AI. Furthermore, the generative AI performs correlation analysis by combining past risk occurrence cases or an external database and currently acquired data, quantitatively predicts a probability of risk occurrence and a degree of impact, and also performs composite risk evaluation when a plurality of risks occur simultaneously. Specifically, the risk analysis unit executes a multimodal integration model that maps text, image, and voice to a common latent space. Input data to the integration model is a preprocessed text vector, an image feature amount tensor, and a mel-frequency cepstral coefficient array of voice. Elements of the input data include a high-dimensional numerical array extracted from each modality. The risk analysis unit executes preprocessing of linear transformation for unifying the number of dimensions of each modality on the input data. As a specific example, the input data includes an embedding vector of a news article, a two-dimensional feature map of a surveillance camera image, and a voice feature amount indicating an angry voice of a customer. The integration model calculates a correlation between different modalities using a cross-attention mechanism. Output data from the integration model is a high-dimensional context vector integrating features of each modality, and a composite risk score based thereon. Each value of the output data means the severity of a crisis faced by the entire system as a numerical value from zero to one hundred. As a specific example, the output data includes a 1024-dimensional context vector, and a numerical value of a composite risk score of 85. The risk analysis unit uses this output result for generation of an emergency response flag in subsequent processing. When the composite risk score exceeds 80, which is a predetermined threshold value, the risk analysis unit generates an emergency response flag and immediately transmits it to the countermeasure planning unit. The risk analysis unit exhibits a technical effect of highly accurate risk detection by combining minute signs that are overlooked in a single data source. This effect is brought about by an architecture that integrates multimodal data and learns non-linear relationships. The risk analysis unit is extremely useful in a specific application field of a smart city platform that integrally manages crime prevention and disaster prevention of an entire city. Furthermore, the risk analysis unit can also adopt a configuration that integrates determination results of each modality by ensemble learning as an alternative method.

The countermeasure planning unit automatically generates a plurality of optimal countermeasures according to a risk level and a type of risk while referring to past response cases, internal regulations, external best practices, industry guidelines, laws and regulations, contract conditions, agreements with customers, contract conditions with business partners, and the like using generative AI based on a risk determination result by the risk analysis unit. For example, the countermeasure planning unit automatically generates specific action plans such as “securing employee safety”, “emergency stop of equipment”, “reconstruction of supply chain”, “notification of impact to customers”, “securing evacuation route”, “investigation of damage situation at local base”, and “cooperation with local government” for an earthquake risk, “system blocking”, “backup activation”, “contact to related department”, “preparation for legal response”, “contact to external expert”, and “temporary blocking of customer information” for a cyber attack risk, and “official statement announcement by public relations department”, “strengthening of SNS monitoring”, “expansion of customer response window”, “immediate update of FAQ”, “automatic generation of apology text”, and “identification of impact range” for a flaming risk. The generative AI automatically creates reports and alert notifications whose contents are optimized for each related party such as for management, for a department in charge, for an on-site person in charge, for a business partner, and for a customer, and rapidly distributes them through a management screen on the terminal side, a mobile terminal, an e-mail, a chat system, a voice call, a push notification, and the like. Specifically, the countermeasure planning unit executes accurate text generation based on facts using a retrieval-augmented generation technology. Input data to the countermeasure planning unit is an emergency response flag and a context vector from the risk analysis unit. Elements of the input data include a high-dimensional numerical array expressing a current crisis situation. The countermeasure planning unit executes preprocessing of query conversion to a vector database on the input data. As a specific example, the input data includes a flag indicating occurrence of a cyber attack, and a vector indicating features of an attack method. The countermeasure planning unit retrieves text embedding vectors of similar past response cases and related laws and regulations from the vector database, and inputs them to a large language model as a prompt. Output data from the language model is a list of specific action items according to a role of each related party and an explanatory text in natural language. Each value of the output data means a set of tasks structured in a JSON array format. As a specific example, the output data includes a server blocking task for an information system department, a reporting task to authorities for a legal department, and a text describing execution procedures thereof. The countermeasure planning unit uses this output result for registration in a task queue of the execution management unit in subsequent processing. The countermeasure planning unit parses the generated JSON array and assigns each task to an asynchronous worker. The countermeasure planning unit exhibits technical effects of suppressing factless output and automatically generating an executable countermeasure strictly compliant with internal regulations and laws and regulations. This effect is brought about by an architecture that combines dynamic retrieval of an external knowledge base and a generative model. The countermeasure planning unit is extremely useful in a specific application field of incident response in a medical institution or a financial institution where compliance requirements are extremely strict. Furthermore, the countermeasure planning unit can also adopt a configuration that verifies a generation result by using a decision tree-based rule engine together as an alternative method.

The execution management unit automatically executes a countermeasure in cooperation with a related internal system for a countermeasure plan approved by the countermeasure planning unit. For example, the execution management unit automatically implements inventory adjustment according to a disaster risk in cooperation with an inventory management system, automates system switching and backup activation in cooperation with a system of an information system department, automatically assigns a person in charge in cooperation with an employee management system, automatically changes a delivery route in cooperation with a logistics system, and automates simultaneous notification to affected customers in cooperation with a customer management system. Furthermore, the execution management unit also performs effect verification and automatic monitoring of a progress status after execution of the countermeasure, and automatically generates an additional countermeasure again as necessary. Specifically, the execution management unit manages reliable execution of a distributed transaction using a workflow engine. Input data to the execution management unit is an action item in a task queue registered from the countermeasure planning unit. Elements of the input data include an endpoint of a target system, a method to be executed, and payload data. The execution management unit executes preprocessing of analysis of dependency relationships and scheduling of an execution order on the input data. As a specific example, the input data includes a backup activation command of a database, and a subsequent shutdown command of a main server. The execution management unit transmits a request by a remote procedure call or a hypertext transfer protocol to each external system. Output data from the execution management unit is a response code from each system and JSON data of an execution result. Each value of the output data means success or failure of processing, and time taken for the processing. As a specific example, the output data includes a status code of 200 indicating success, and a message character string indicating completion of backup. The execution management unit uses this output result for status update and error handling in subsequent processing. When a timeout or an error occurs, the execution management unit executes retry processing using an exponential backoff algorithm, and activates an alternative flow when failing a specified number of times. The execution management unit exhibits technical effects of reliable execution of a complex response process spanning a plurality of systems and realization of automatic recovery when a failure occurs. This effect is brought about by a distributed transaction management mechanism that persists state transitions and guarantees rollback at the time of failure. The execution management unit is extremely useful in a specific application field of automatic failover and automatic compensation processing to customers when a server goes down in a large-scale electronic commerce site. Furthermore, the execution management unit can also adopt a configuration that completely tracks state changes of the system using an event sourcing pattern as an alternative method.

The progress monitoring unit monitors a progress status of all risk response processes in real time, and visualizes an implementation status of each countermeasure, an unaddressed matter, a delay occurrence location, feedback from a site, occurrence of an additional risk, and the like in a dashboard format. For example, when an on-site person in charge reports a damage situation with a photo from a mobile terminal, the information is immediately reflected in the entire system so that management and a crisis management department can grasp the latest situation. When a response delay or an unaddressed risk is detected, the progress monitoring unit transmits an automatic alert to related parties to prompt a rapid additional response. Specifically, the progress monitoring unit constructs a real-time data pipeline using a stream processing engine. Input data to the progress monitoring unit is a status update event stream from the execution management unit, and feedback data from an on-site terminal. Elements of the input data include a numerical value indicating a progress degree of a task, a text report of a site, and an image binary. The progress monitoring unit executes preprocessing of aggregation and filtering based on a time window on the input data. As a specific example, the input data includes a status update of an evacuation completion rate of 80%, and photo data indicating an inundation situation at the site. The progress monitoring unit caches these data in an in-memory database to enable high-speed reading. Output data from the progress monitoring unit is aggregated data for dashboard drawing and an alert trigger signal. Each value of the output data means a percentage of a task completion rate, a list of delayed tasks, and a warning level. As a specific example, the output data includes an overall progress rate of 75%, a flag indicating a response delay in a specific department, and a red alert signal. The progress monitoring unit uses this output result for push notification to a client terminal in subsequent processing. The progress monitoring unit dynamically updates a screen of the client terminal in milliseconds via WebSocket communication. The progress monitoring unit exhibits technical effects of speeding up decision-making by sharing information without delay and early discovery of a bottleneck. This effect is brought about by in-memory processing eliminating disk input/output and an asynchronous data distribution mechanism by a publish-subscribe model. The progress monitoring unit is extremely useful in a specific application field of dynamic management of security staff and supervision of incident response in a large-scale event venue. Furthermore, the progress monitoring unit can also adopt batch updating by periodic polling to reduce a server load as an alternative method.

The user interface unit is mainly realized on the terminal side, and provides functions necessary for a user interface and on-site response, such as dashboard display for each related party, reception of alert notifications, input of status reports and response statuses by an on-site person in charge, decision-making and approval operations by management, confirmation of emergency response instructions on site, voice input and image upload, automatic analysis of on-site photos, automatic transcription of on-site voices, and transmission of feedback from the site. For example, the on-site person in charge reports a damage situation with a photo from a mobile terminal, or the management presses an approval button for a countermeasure plan on the terminal, whereby an automatic execution process on the server side is started. Specifically, the user interface unit utilizes edge artificial intelligence in a front-end application and implements asynchronous communication. Input data to the user interface unit are a touch operation event from a user, voice waveform data from a microphone, and an image frame from a camera. Elements of the input data include coordinate values on a screen, an array of sampled sound pressure levels, and RGB values of pixels. The user interface unit executes preprocessing such as noise removal and resolution adjustment on a local device for the input data. As a specific example, the input data includes tap coordinates of the approval button, voice data talking about the damage situation on site, and an on-site photo taken by a camera of a smartphone. The user interface unit executes inference using a neural network processing unit built in the terminal. Output data from the user interface unit are a text conversion result by a voice recognition model, an initial determination label by an image classification model, and a transmission request payload to the server. Each value of the output data means a transcribed character string, a category of an object shown in the image, and structured data in a JSON format. As a specific example, the output data includes a text stating that there is a crack in a wall, a label of damage, and transmission data storing them. The user interface unit uses this output result for data synchronization to the server in subsequent processing. Under an offline environment, the user interface unit temporarily stores the output data in a local encrypted storage, and automatically synchronizes it to the server by a background process when a network connection is restored. The user interface unit exhibits technical effects of providing a seamless user experience independent of a communication environment and reducing a load on the server side. This effect is brought about by advanced information processing on the edge side and an asynchronous queuing mechanism that monitors a network state. The user interface unit is extremely useful in a specific application field of a support system for infrastructure inspection workers in radio dead zones such as underground facilities and mountainous areas. Furthermore, as an alternative method, the user interface unit can also adopt a configuration that provides functions equivalent to a native application on a browser using progressive web application technology.

An external cooperation unit exchanges information in real time with a crisis management system of another company, a cross-industry information sharing platform, a disaster prevention system of a local government, a supply chain management system of a business partner, a CRM system of a customer, and the like by API cooperation. For example, disaster information from a local government is automatically acquired, delivery delay information from a business partner is automatically received, an alert from an industry group is automatically reflected, and inquiry contents from a customer are automatically analyzed. Specifically, the external cooperation unit of the present system executes an asynchronous communication protocol. The cooperation unit transmits and receives serialized data. The cooperation unit converts the received external data into a multidimensional tensor. The cooperation unit supplies the converted tensor to an input layer of a large language model. The cooperation unit parses disaster information in an extensible markup language format from a local government system. The cooperation unit inputs the parsed information to a natural language processing model. The model receives a text character string indicating a type and an occurrence location of a disaster as input data. The model outputs a continuous value score from 0 to 1 indicating a severity of the disaster. The system activates an emergency alert process when this score exceeds a predetermined threshold. Thereby, a communication overhead between systems is reduced. This configuration is applied to real-time risk detection in supply chain management.

A learning and evolution unit continuously learns new risk patterns and countermeasures using generative AI, and improves accuracy and response capability of the entire system. For example, even for a new type of cyber attack responded to in the past, an unprecedented natural disaster, a new establishment of laws and regulations, and the like, the generative AI automatically expands a knowledge base and reflects it in risk prediction and countermeasure planning from the next time onward. Specifically, the learning and evolution unit of the present system includes a dedicated arithmetic processor group that executes reinforcement learning and fine-tuning. The learning and evolution unit vectorizes a past risk response history. The learning and evolution unit uses the vectorized history data as training data. The learning and evolution unit updates weight parameters of a large language model by a backpropagation method. The learning and evolution unit applies a gradient descent method so as to minimize a cross-entropy error function. The learning and evolution unit receives a 512-dimensional text embedding vector and a time-series corresponding action array as input data. The model generates a softmax vector indicating a probability distribution of an optimal countermeasure against a new risk as an output. The system registers the countermeasure with the highest probability in a database as an initial response template for the next time. Thereby, an adaptive capability of the system to an unknown cyber attack is improved. This configuration is applied to an unauthorized access detection system of a financial institution.

A security management unit performs encryption of communication between the server and the terminal, strict management of access authority, automatic analysis of access logs and operation histories, detection of signs of unauthorized access and internal fraud, immediate alert transmission to a system administrator, and the like. For example, when an access from an unusual time zone or location is detected, the system administrator is automatically notified, and an access restriction is implemented as necessary. Specifically, the security management unit of the present system executes encryption and decryption processing of a communication packet using a hardware security module. The management unit applies an advanced encryption standard algorithm. The management unit converts an access log into a time-series multidimensional vector. The management unit inputs the converted vector to an autoencoder network for abnormality detection. The network receives a feature vector including a user identifier, an access time, and an IP address as input data. The network compresses the input vector into a low-dimensional latent space. The network reconstructs the original vector from the latent space. The network generates a reconstructed feature vector as an output. The network calculates a reconstruction error between the input vector and the output vector. The management unit determines a case where the reconstruction error exceeds a predetermined threshold as a sign of unauthorized access. The management unit automatically blocks communication from the corresponding IP address with a firewall based on a determination result. Thereby, defense accuracy against internal fraud and zero-day attacks is dramatically improved. This configuration is applied to database protection of a government agency handling confidential information.

Specific examples of prompt sentences to be read by the generative AI when implementing the present invention include “Extract risk factors related to our company from the following SNS post group, and predict a probability of occurrence and a degree of impact”, “Detect signs of equipment abnormality from time-series changes in the following IoT sensor data, and propose three recommended initial countermeasures”, “Compare the following news articles with past disaster cases, and generate a composite risk scenario that may occur within the next 24 hours”, “Refer to the following on-site reports and internal regulations, and automatically generate specific action instructions for an on-site person in charge”, and “Analyze the following progress status data, and list unaddressed risks and additional countermeasures”. These prompt sentences are used to instruct specific analysis and generation tasks when utilizing the generative AI in each unit of the system. Specifically, the present system includes a prompt engineering module that dynamically generates these prompt sentences. The module converts input raw data into a token sequence interpretable by a natural language processing model. The module tokenizes text data by byte-pair encoding. The module supplies the tokenized data as a 768-dimensional input tensor to a large language model. The model calculates a dependency relationship between each token in the input tensor by a self-attention mechanism. The model outputs a classification label of a risk factor, a floating-point number from 0.0 to 1.0 indicating a probability of occurrence, and categorical data indicating a degree of impact as an output. The system automatically activates a subsequent countermeasure planning module when the output probability value is 0.8 or more. Thereby, a manual prompt input operation by a human operator is eliminated. This configuration is applied to automatic triage of complaints in a large-scale customer support center.

### Implementation Steps

Step 1: Real-time collection of multidimensional information In this step, data is automatically collected in real time from a very diverse range of information sources, such as internal and external news sites, SNS, weather information providing organizations, market data vendors, electronic data interchange systems of business partners, customer inquiry management systems, IoT sensor networks, surveillance camera systems, employee business report applications, open data APIs of local governments and public institutions, and alert distribution services of industry groups, by means such as API cooperation, RSS feeds, email reception, file transfer, via chatbots, web scraping, IoT gateways, and image recognition AI. For example, posts such as “defect report of own product” and “disaster site photo of local employee” are acquired from SNS, data such as “typhoon course prediction” and “heavy rain warning” are acquired from weather information, and data such as “abnormal vibration of factory equipment” and “rapid rise in warehouse temperature” are acquired from IoT sensors. Specifically, in this step, the information collection unit processes a plurality of data streams in parallel using a distributed processing framework. The collection unit parses a document object model tree from hypertext markup language data acquired by web scraping. The collection unit extracts a text node from a parsing result. The collection unit inputs the extracted text to a natural language processing model. The collection unit buffers time-series numerical values acquired from a sensor in a memory as one-dimensional array data. The collection unit inputs a high-resolution pixel value tensor acquired from a surveillance camera to an image recognition model. The image recognition model extracts a feature map in an image using a convolutional neural network. The image recognition model outputs bounding box coordinates and class probabilities of objects included in the image as an output. The system asynchronously writes these collected data into an integrated database. Thereby, an input/output bottleneck in data collection of heterogeneous formats is resolved. This configuration is applied to a wide-area disaster monitoring network in a smart city.
Step 2: Data preprocessing and attribute assignment The collected data is accumulated in a database on the server, and is automatically classified and tagged by various attributes such as time series, occurrence area, related department, degree of impact, reliability of information, information transmission source, data type, degree of urgency, related business area, business partner name, and customer name. Preprocessing such as deduplication, noise removal, reliability scoring, time-series correction of information, assignment of geographic information, and automatic caption generation of image data is also automatically performed. For example, among SNS posts, those including “own company name+failure+local photo” are tagged as “failure risk”, “site”, and “high urgency”. Specifically, in this step, a data preprocessing unit executes an operation of normalizing and standardizing the collected data. The preprocessing unit performs stop word removal and stemming processing on text data. The preprocessing unit vectorizes the processed text by an algorithm based on a term frequency and an inverse document frequency. The preprocessing unit inputs the vectorized data to a support vector machine. The preprocessing unit applies a pre-trained image caption generation model to image data. The model outputs a natural language text character string describing contents of an image from an input image tensor. The preprocessing unit applies a moving average filter to time-series data to remove high-frequency noise. The preprocessing unit calculates a reliability score based on past accuracy of an information source for each data. The preprocessing unit excludes data whose reliability score is less than a reference value from subsequent processing. Thereby, quality of input data to a risk analysis model is ensured, and inference accuracy is improved. This configuration is applied to signal generation of algorithmic trading in a financial market.
Step 3: Risk factor extraction and analysis by generative AI In this step, generative AI is used. The generative AI extracts keywords, phrases, emotional expressions, causal relationships, time-series changes, intentions of related parties, and the like that become risk factors from unstructured text data such as news articles, SNS posts, internal reports, and customer inquiry contents by natural language processing, detects abnormal values and rapid changes from numerical data such as IoT sensor data and market data using pattern recognition and time-series analysis, automatically determines fire smoke, suspicious person intrusion, on-site damage situations, and the like from surveillance camera videos using image recognition AI, and evaluates severity and urgency of complaints from call contents of a customer call center using voice recognition AI. Specific examples of prompt sentences include “Extract risk factors related to our company from the following SNS post group, and predict a probability of occurrence and a degree of impact”, “Detect signs of equipment abnormality from time-series changes in the following IoT sensor data, and propose three recommended initial countermeasures”, and “Compare the following news articles with past disaster cases, and generate a composite risk scenario that may occur within the next 24 hours”. Specifically, in this step, the risk analysis unit executes a large language model in which a plurality of transformer layers are stacked on a parallel computing cluster. The analysis unit inputs a preprocessed text vector, a time-series numerical array, and an image feature tensor to a multimodal integration layer. The integration layer maps data of different modalities to the same latent space. The model receives a 1024-element time-series array indicating vibration data of factory equipment as input data. The model learns long-term dependency of time-series data using a self-attention mechanism. The model outputs a one-hot vector indicating a category of a risk factor and an output value of a sigmoid function indicating a probability of abnormality occurrence as an output. The system determines necessity of executing a subsequent risk scenario generation process based on the output probability value. Thereby, it becomes possible to detect a minute abnormal pattern that cannot be visually confirmed by a human. This configuration is applied to a predictive maintenance system in a chemical plant.
Step 4: Risk scenario generation and risk level determination The generative AI performs correlation analysis by combining past risk occurrence cases or an external database and currently acquired data, quantitatively predicts a probability of risk occurrence and a degree of impact, and also performs composite risk evaluation when a plurality of risks occur simultaneously. The generative AI automatically determines a risk level such as a major risk, a medium risk, and a minor risk according to a severity of the risk, and performs prioritization for each type of risk. Specific examples of prompt sentences include “Generate a plurality of risk scenarios that may occur based on the following data, and quantitatively evaluate a probability of occurrence and a degree of impact of each”, and “Analyze a composite risk when a plurality of risk factors occur simultaneously, and list them with prioritization”. Specifically, in this step, a scenario generation unit executes a Markov chain Monte Carlo method using an extracted risk factor vector as an initial state. The generation unit simulates a future state transition using a transition probability matrix extracted from a past incident database. The generation unit inputs a list of currently occurring risk factors and a tensor of environmental variables to a large language model. The model outputs a text description of a plurality of risk scenarios that may occur, a floating-point number indicating a probability of occurrence of each scenario, and a score indicating a degree of impact as an output. The system calculates a product of the output probability of occurrence and degree of impact, and determines a comprehensive risk score. The system compares the comprehensive risk score with a predetermined threshold group, and assigns class labels of major, medium, and minor. The system registers a scenario determined as a major risk in a priority queue. Thereby, calculation efficiency for quantitatively evaluating a chain of composite risks is improved. This configuration is applied to dynamic routing in a flight management system of an airline company.
Step 5: Automatic Countermeasure Planning by Generative AI Based on a risk determination result by the risk analysis unit, a plurality of optimal countermeasures according to a risk level and a type of risk are automatically generated using generative AI while referring to past response cases, internal regulations, external best practices, industry guidelines, laws and regulations, contract conditions, agreements with customers, contract conditions with business partners, and the like. For example, specific action plans are automatically generated, such as “securing employee safety,” “emergency stop of equipment,” “reconstruction of supply chain,” and “notification of impact to customers” for an earthquake risk, “system blocking,” “backup activation,” “contact to related departments,” and “preparation for legal response” for a cyber attack risk, and “official statement announcement by public relations department,” “enhancement of SNS monitoring,” and “expansion of customer response counters” for a flaming risk. Specific examples of prompt sentences include “Propose a plurality of optimal countermeasures for each risk level based on the following risk analysis results and past response cases,” “Automatically generate a specific action plan for the following risk scenario with reference to internal regulations and external guidelines,” and the like. Specifically, in this step, the countermeasure planning unit executes a reinforcement learning-based recommendation algorithm. The planning unit defines a state vector indicating a risk level, a risk category, and a current resource status as environmental information. The planning unit inputs this state vector to a neural network using a policy gradient method. The network outputs a probability distribution of a plurality of possible countermeasure actions as an output. The planning unit inputs an identifier of the selected action and a text embedding vector of a related internal regulation to a large language model. The model outputs step-by-step text data in natural language indicating a specific action procedure as an output. The system converts the output action procedure into a structured data format and transmits it to an execution management module. This makes it possible to generate an optimal countermeasure according to the situation in milliseconds. This configuration is applied to a crowd guidance and anti-terrorism system in a large-scale event venue.
Step 6: Automatic Generation and Distribution of Reports and Alerts by Related Party The generative AI automatically creates reports and alert notifications whose contents are optimized for each related party such as for management, for a department in charge, for an on-site person in charge, for a business partner, and for a customer, and rapidly distributes them through a management screen on a terminal side, a mobile terminal, an e-mail, a chat system, a voice call, a push notification, and the like. For example, a report summarizing an overall picture of the risk and key points necessary for decision-making is provided to the management, specific work instructions and a list of emergency contacts are provided to the on-site person in charge, a dashboard visualizing overall progress and response status in real time is provided to a crisis management department, and a notification text briefly summarizing an impact range and a response policy is provided to the customer. Specific examples of prompt sentences include “Automatically generate a summary report for management based on the following countermeasures,” “Automatically generate specific action instructions for on-site personnel,” “Create a notification text briefly summarizing an impact range and a response policy for customers,” and the like. Specifically, in this step, a report generation unit executes text summarization and style conversion according to a target audience using a natural language generation model. The generation unit receives structured data of the generated countermeasure, detailed text of the risk scenario, and a profile vector indicating an attribute of a recipient as input data. The model assigns a weight to information most relevant to the attribute of the recipient using an attention mechanism. The model generates a high-level summary text for the management, a bulleted instruction text for the on-site person in charge, and a polite-tone notification text for the customer, respectively, as outputs. The system formats the generated text into an e-mail format or a payload format for push notification. The system asynchronously transmits data to each distribution channel using a message queuing protocol. This minimizes a delay in information transmission and optimizes consumption of a network bandwidth. This configuration is applied to a crisis management public relations platform of a global company.
Step 7: Automatic Countermeasure Execution and Progress Monitoring For an approved countermeasure plan, an execution management unit automatically executes a countermeasure in cooperation with a related internal system. For example, inventory adjustment according to a disaster risk is automatically executed in cooperation with an inventory management system, system switching and backup activation are automated in cooperation with a system of an information system department, a person in charge is automatically assigned in cooperation with an employee management system, a delivery route is automatically changed in cooperation with a logistics system, and simultaneous notification to affected customers is automated in cooperation with a customer management system. A progress monitoring unit monitors a progress status of all risk response processes in real time, visualizes an implementation status of each countermeasure, an unaddressed matter, a delay occurrence location, feedback from a site, occurrence of an additional risk, and the like in a dashboard format, and automatically transmits an alert to a related party to prompt a rapid additional response when a response delay or an unaddressed risk is detected. Specifically, in this step, the execution management unit controls calls of application programming interfaces to a plurality of external systems using an orchestration engine. The management unit parses a group of executable commands from the data of the generated countermeasure. The management unit transmits a request instructing inventory movement to the inventory management system. The progress monitoring unit receives a callback from each system and analyzes a status code. The monitoring unit holds an array of Boolean values indicating a completion state of each task on a memory. The monitoring unit sets a delay flag when an execution time of a task exceeds a specified timeout value. When the delay flag is detected, the monitoring unit activates an escalation process and transmits a trigger signal for recalculating an alternative countermeasure to the countermeasure planning unit. This prevents omission of execution or delay of a countermeasure at a system level. This configuration is applied to emergency evacuation control in fleet management of autonomous driving vehicles.
Step 8: System Accuracy Improvement by Learning and Evolution A learning and evolution unit continuously learns a new risk pattern and countermeasure using generative AI, and improves accuracy and response capability of the entire system. For example, even for a new type of cyber attack responded to in the past, an unprecedented natural disaster, a new establishment of laws and regulations, and the like, the generative AI automatically expands a knowledge base and reflects it in risk prediction and countermeasure planning from the next time onward. Specific examples of prompt sentences include “Learn the following new risk case and reflect it in a future risk prediction model,” “Evaluate an effect of a past countermeasure and update an optimal countermeasure pattern,” and the like. Specifically, in this step, the learning and evolution unit dynamically updates a parameter of an inference model using an online learning algorithm. The learning unit collects feedback data indicating a result of the executed countermeasure and a subsequent change in a risk state. The learning unit converts this feedback data as a reward signal. The learning unit updates an action-value function of a reinforcement learning agent. The learning unit vectorizes text data of a newly observed risk case and adds it to a vector database. The learning unit inputs a prompt including the new case to a large language model and executes fine-tuning of the model. The learning unit uses a contrastive loss as a loss function and adjusts a weight so that embedding vectors of similar risk patterns approach each other in a latent space. This allows the system to autonomously acquire a response capability against an unknown threat without human intervention. This configuration is applied to an autonomous security operations center of a cloud infrastructure.

### Specific Use Case

For example, a case where a company having manufacturing bases and logistics bases in a plurality of countries and regions introduces the crisis management system of the present invention will be described. The information collection unit automatically collects data in real time from local news sites of each base, SNS, weather information providing organizations, disaster information APIs of local governments, electronic data interchange systems of business partners, IoT sensor networks, surveillance camera systems, employee business report applications, and the like. For example, data such as a post saying “large-scale road flooding occurred around the local logistics center” from SNS, a forecast saying “the path of a typhoon will pass near the logistics base” from weather information, and “the temperature in the warehouse rises rapidly” and “the vibration value of the equipment shows an abnormal value” from IoT sensors are acquired. A data preprocessing unit automatically classifies and tags this information by attributes such as time series, occurrence area, related department, degree of impact, reliability of information, information transmission source, data type, degree of urgency, related business area, and business partner name, and performs noise removal, deduplication, reliability scoring, addition of geographic information, and the like. Specifically, in the present embodiment, the information collection unit includes a geospatial data processing module. The collection unit receives a payload including global positioning system coordinate data transmitted from each base. The collection unit analyzes news articles and posts written in a local language using a multilingual natural language processing model. The model converts the input multilingual text into a language-independent common semantic space vector. The data preprocessing unit applies a Kalman filter to a time-series array of the acquired sensor data to perform interpolation of missing values and smoothing of noise. The preprocessing unit assigns a spatial index based on a time stamp and geographic coordinates to each data point. The preprocessing unit stores these data in a distributed graph database and defines a relationship between nodes as an edge. This significantly reduces a delay in search and aggregation processing for a vast data stream on a global scale. This configuration is applied to logistics monitoring of a manufacturing industry having an international supply chain network.

The risk analysis unit extracts a plurality of risk factors such as “road flooding around a logistics base,” “typhoon approach,” “abnormal temperature in a warehouse,” and “abnormal equipment vibration” using generative AI, and quantitatively predicts a risk occurrence probability and a degree of impact by collating them with past disaster cases, logistics failure cases, equipment failure cases, weather databases, and the like. The generative AI generates a composite risk scenario when a plurality of risks occur simultaneously, and presents scenarios such as “a possibility that shipment from a logistics base will be delayed for 48 hours or more when a typhoon approach and road flooding overlap” and “a risk of quality deterioration of inventory products and equipment stoppage increases when an abnormal temperature in a warehouse and an abnormal equipment vibration occur simultaneously.” Specific examples of prompt sentences include “Generate a risk scenario related to a logistics base based on the following SNS posts, weather information, IoT sensor data, and past disaster cases, and evaluate an occurrence probability and a degree of impact of each,” “Analyze a composite risk when a plurality of risk factors occur simultaneously, and list them with prioritization,” and the like. Specifically, in the present embodiment, the risk analysis unit simulates propagation of a composite risk using a graph neural network. The analysis unit extracts a subgraph centered on a specific logistics base from the graph database constructed by the preprocessing unit. The analysis unit inputs an adjacency matrix and a feature matrix of the extracted subgraph to a graph convolutional network. The network executes message passing between nodes and calculates an interaction of risk factors. The analysis unit inputs an output vector of the graph network and a time-series tensor of weather data to a large language model. The model outputs a continuous value from 0 to 1 indicating a probability that a specific base will fall into a functional stoppage, and a list of other bases to which an impact spreads, as outputs. The system calculates a vulnerability score of the entire supply chain based on this output result. This makes it possible to predict a chain failure caused by a single event with high accuracy based on a mathematical model. This configuration is applied to optimization of a global procurement network of a multinational company.

The countermeasure planning unit automatically generates a plurality of specific countermeasures according to a risk level and a type of risk, such as “judgment of shipment stoppage at a logistics base,” “automatic selection of an alternative route,” “temporary movement of inventory products,” “securing safety of local employees,” “emergency stop of equipment,” “notification of delivery delay to customers,” “contact to business partners,” and “cooperation with local governments,” using generative AI. Furthermore, it automatically generates reports and alert notifications optimized for each related party, such as “a report summarizing an overall risk and decision-making points” for management, “an alternative route plan and criteria for resuming shipment” for a logistics department, “a procedure for securing safety on site and a list of emergency contacts” for an on-site person in charge, and “a notification text briefly summarizing a prospect of delivery delay and a response policy” for customers, and distributes them through a terminal, an e-mail, a chat system, and the like. Specific examples of prompt sentences include “Automatically generate specific action instructions for an on-site person in charge of a logistics base based on the following risk analysis results and past response cases,” “Create a notification text briefly summarizing a prospect of delivery delay and a response policy for customers,” and the like. Specifically, in the present embodiment, the countermeasure planning unit executes a combination of a constrained optimization solver and a generative model. The planning unit formulates a linear programming problem using an inventory amount, a transportation cost, and a lead time of each base as variables. The planning unit inputs a base stoppage probability output from the risk analysis unit to the solver as a constraint condition. The solver outputs a numerical solution of an optimal alternative route and an inventory movement amount that maximizes a profit or minimizes a loss of the entire supply chain. The planning unit inputs an array of this numerical solution and a profile vector indicating context information of each related party to a large language model. The model generates a specific instruction text or notification text in which numerical data is translated into natural language as an output. The system distributes the generated text via a module that automatically translates it into an official language of each country. This converts a result of complex mathematical optimization into a format that can be immediately executed by a person on site. This configuration is applied to dynamic reconstruction of a ship allocation schedule in an international shipping industry.

For an approved countermeasure plan, the execution management unit automatically executes temporary movement of inventory products in cooperation with an inventory management system, automatically sets an alternative delivery route in cooperation with a logistics system, automatically transmits shift adjustment and safety securing instructions for local employees in cooperation with an employee management system, and automates simultaneous notification to affected customers in cooperation with a customer management system. The progress monitoring unit monitors a progress status of all risk response processes in real time, visualizes an implementation status of each countermeasure, an unaddressed matter, a delay occurrence location, feedback from a site, occurrence of an additional risk, and the like in a dashboard format, and automatically transmits an alert to a related party to prompt a rapid additional response when a response delay or an unaddressed risk is detected. Specifically, in the present embodiment, the execution management unit executes distributed transaction control based on a microservices architecture. The management unit divides the planned countermeasure into a plurality of independent tasks, and assigns each task to a containerized worker process. The management unit issues an idempotent request to the inventory management system and the logistics system. The progress monitoring unit receives a survival confirmation signal and status update data periodically transmitted from each worker process. The monitoring unit stores the received data in an in-memory data grid and aggregates it using a real-time stream processing engine. The monitoring unit fires an abnormality detection event when completion of a specific task is delayed by a predetermined threshold or more from a scheduled time. The system automatically activates an alternative worker process triggered by this event. This improves fault tolerance against a communication failure or a system failure in a global network. This configuration is applied to fulfillment automation of a cross-border e-commerce platform.

The learning and evolution unit accumulates, for example, “an entire process of responding to a logistics failure caused by this typhoon,” “an initial response at the time of an equipment abnormality and its effect,” “a reaction to a notification of delivery delay to a customer,” and the like as learning data using generative AI, and reflects them in improving accuracy of risk prediction and countermeasure planning from the next time onward. Specific examples of prompt sentences include “Learn a history of the following risk response process and update an optimal countermeasure pattern at the time of a future logistics failure,” “Analyze a past customer notification text and a customer reaction, and construct a more effective notification text generation model,” and the like. Specifically, in the present embodiment, the learning and evolution unit integrally learns data of each base using a federated learning framework. The learning unit executes learning of a local model on an edge server arranged at each base. The learning unit transmits only an update difference of a weight parameter of the local model to a central aggregation server. The aggregation server averages a plurality of received update differences and updates a parameter of a global model. The learning unit inputs a pair of a past response history text and a customer satisfaction score obtained as a result thereof to a large language model as training data. The model adjusts an internal weight by supervised fine-tuning so that a generation probability of a notification text that brings higher customer satisfaction increases. This improves prediction accuracy and response quality of the entire system without transmitting confidential data of each base to the outside. This configuration is applied to a medical institution network that shares global knowledge while complying with data protection regulations of each country.

As described above, the crisis management system of the present invention can automate everything from information collection, risk analysis, scenario generation, countermeasure planning, notification by related party, countermeasure execution, progress monitoring, to learning and evolution in an integrated manner with generative AI at its core, even in a site where multiple bases, diverse information sources, and complex risk factors are intertwined, thereby enhancing corporate business continuity and social credibility. Specifically, in the present embodiment, the system comprises a central control processor that integrates these functional modules. The processor adopts an event-driven architecture and controls a data flow between the modules via an asynchronous message queue. The system executes a series of processes from an input multidimensional sensor data tensor to a final execution command group of a countermeasure as an autonomous pipeline that does not require human intervention. The system records a calculation result in each processing step as a hash value in a distributed ledger on a blockchain network. Thereby, transparency and tamper resistance of the entire crisis management process are cryptographically guaranteed. This configuration is applied to a compliance management system of a financial institution that requires strict management of audit trails.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

In the embodiment of the present invention, a data center crisis management system is composed of a plurality of functional units such as a data collection unit, a risk analysis unit, a countermeasure planning and execution unit, a progress monitoring unit, a learning and evolution unit, an external cooperation unit, a user interface unit, and a security management unit. Detailed descriptions will be given from all perspectives, such as a specific configuration and function of each unit, utilization of generative AI, role sharing between a server and a terminal, an actual operation example, expandability, security, a user interface, external system cooperation, and a self-learning function. Specifically, in the present embodiment, the data center crisis management system adopts a hybrid architecture in which an edge computing node and a cloud server group operate cooperatively. The system deploys each functional unit as an independent microservice on a container orchestration platform. In the data collection unit, the system operates a time-series database in-memory for processing millions of metrics data per second. In the risk analysis unit, the system accelerates inference of a large language model using dedicated hardware equipped with a tensor processing unit. In the countermeasure planning and execution unit, the system cooperates with a controller of a software-defined network to enable dynamic change of a network topology. Thereby, a self-healing capability of the system against physical and logical failures in a data center is realized. This configuration is applied to autonomous infrastructure operation of a large-scale cloud provider.

First, the data collection unit automatically acquires real-time data from various sensors and monitoring devices such as a power system, a cooling device, security monitoring, fire detection, human monitoring, and network monitoring in the data center. For example, from the power system, an operating status of a main power supply, a standby power supply, and an emergency generator, voltage, current, frequency, a power supply switching state, a remaining battery level of a UPS, a history at the time of occurrence of a power failure, a transition of power consumption, and the like are acquired. From the cooling device, a cooling water pressure, a refrigerant temperature, a fan rotation speed, an operating status of a cooling tower, an abnormality alarm, a maintenance history of the cooling device, a transition of cooling capacity, and the like are acquired. From the security monitoring, an entry/exit record, suspicious access, a surveillance camera image, a biometric authentication log, a patrol record of a security guard, a door opening/closing history, an operation history of an alarm device, and the like are acquired. From the fire detection, smoke detection, a temperature rise, a fire alarm, an operating status of fire extinguishing equipment, an on-site image at the time of fire occurrence, a remaining amount of a fire extinguishing agent, a maintenance history of a fire detector, and the like are acquired. From the human monitoring, entry/exit of a worker, a work history, suspicious person detection, a health condition of a worker, a work procedure compliance status, qualification information of a worker, position information of a worker, and the like are acquired. From the network monitoring, a communication delay, a packet loss, a bandwidth usage rate, an external connection status, a sign of a cyber attack, an operating status of a network device, detection of unauthorized communication, a network configuration change history, and the like are acquired. Specifically, in the present embodiment, the data collection unit comprises a multi-protocol gateway that interprets a plurality of industrial communication protocols. The collection unit acquires waveform data of voltage and current of three-phase alternating current from a smart meter of the power system as a time-series array with a high sampling rate. The collection unit reads numerical values of temperature and pressure from a programmable logic controller of the cooling device as 16-bit integer data. The collection unit divides a video stream acquired from a security surveillance camera into image tensors in units of frames. The collection unit serializes these heterogeneous data into a structured object based on a common data schema. The collection unit transfers the serialized data to the subsequent risk analysis unit via a distributed messaging system. The collection unit applies a data compression algorithm during data transfer to minimize consumption of a network bandwidth. Thereby, throughput in data collection from a vast amount of Internet of Things devices is maximized. This configuration is applied to core network equipment monitoring of a large-scale communication carrier.

Furthermore, external weather information, news, SNS, disaster information, and the like are also automatically acquired through an API, RSS, Web scraping, an external cooperation service, and the like. For example, from the weather information, a typhoon approach, a heavy rain warning, a lightning strike advisory, a high temperature advisory, a snowfall forecast, a strong wind warning, an earthquake early warning, a tsunami warning, and the like are acquired. From the news, a fire around the data center, road flooding, power outage information, a traffic obstacle, an accident at a neighboring facility, social disruption, terrorism information, and the like are acquired. From the SNS, a rumor of a power outage, a topic of a cyber attack, a local damage photo, an on-site report from an employee, a complaint from a customer, a social rumor, a reputation of the data center, and the like are acquired. From the disaster information, an earthquake early warning, a tsunami warning, an evacuation instruction, an emergency contact from a local government, an announcement from a disaster countermeasure headquarters, shelter information, traffic regulation information, and the like are acquired. Specifically, the data collection unit periodically transmits a request to an external server using an asynchronous communication protocol. The data collection unit parses the received data in a structured text format. The data collection unit extracts a named entity from the text using a natural language processing model. The data collection unit maps the extracted information to a multidimensional vector space. The data collection unit acquires numerical data such as precipitation, wind speed, and temperature as the weather information as a floating-point array. The data collection unit converts a news text into a word embedding vector. The data collection unit inputs image data of social media to a convolutional neural network. The data collection unit extracts an image feature amount tensor from the image data. Through these processes, the system manages diverse unstructured data in a unified vector format. The system shortens a delay in information collection to a millisecond unit by parallelizing data processing. The system eliminates manual information collection work by a human. The system has a technical effect of fundamentally improving efficiency of data acquisition via a computer network. The system is applied to use cases such as physical protection of a data center and supply chain management.

The data collection unit automatically classifies and tags these diverse data by attributes such as time series, occurrence location, equipment type, degree of abnormality, reliability, information transmission source, data type (text, numerical value, image, audio, video), degree of urgency, related business area, business partner name, and customer name, and performs preprocessing such as deduplication, noise removal, reliability scoring, time-series correction of information, addition of geographic information, automatic caption generation for image data, and automatic transcription of audio data. For example, when an abnormality alarm of the cooling device occurs, it is tagged as “cooling risk”, “high urgency”, and “equipment system”, and among SNS posts, those including “data center name+power outage+local photo” are classified as “power risk”, “site”, and “high reliability”, the reliability of a news article is scored from a transmission source and a past record, and an automatic caption is added to a surveillance camera image. Specifically, the data collection unit inputs the acquired multidimensional vector data to a clustering algorithm. The data collection unit calculates a reliability score of text data using a support vector machine. The data collection unit outputs the reliability score as a floating-point number between 0 and 1. The data collection unit applies a pre-trained image caption generation model to image data. The image caption generation model receives a three-dimensional image tensor as an input. The image caption generation model outputs a sequence of text tokens. The data collection unit executes speech recognition processing using a recurrent neural network on audio data. The data collection unit converts audio waveform data into an acoustic feature amount vector. The data collection unit applies a noise removal filter to improve a signal-to-noise ratio. The data collection unit stores the preprocessed data in a tensor database on a shared memory. Through these preprocessings, the system significantly improves inference accuracy of an artificial intelligence model in a subsequent stage. The system has a technical effect of converting raw data including noise into a clean data structure suitable for machine learning. The system is applied to use cases such as an abnormality detection system and an automatic monitoring system.

The risk analysis unit analyzes a vast amount of data obtained from the data collection unit from multiple angles using generative AI. Using natural language processing, the generative AI extracts keywords, phrases, emotional expressions, causal relationships, time-series changes, intentions of related parties, and the like that become risk factors from unstructured text data such as news articles, SNS posts, internal reports, and worker comments. For example, risk-related words such as “power outage risk”, “cooling abnormality”, “fire alarm”, “cyber attack”, “communication disconnection”, “equipment failure”, “human error”, and “external disaster” are automatically detected, and a type of risk, an occurrence location, and an impact range are estimated according to a context. The generative AI also performs sentiment analysis and topic modeling, and quantitatively evaluates a sign of flaming on SNS, an increase in anxiety of an on-site worker, an increase in complaints from customers, a social rumor risk, and the like. In addition, using pattern recognition and time-series analysis, an abnormal value and a rapid change are detected from numerical data such as sensor data and an equipment log, and for example, a voltage drop in a power system, a temperature rise in a cooling device, an increase in network delay, smoke detection by a fire detection system, and the like are extracted as an abnormal signal. For image data, smoke of a fire, intrusion of a suspicious person, an on-site damage situation, damage to equipment, inappropriate behavior of a worker, and the like are automatically discriminated from a surveillance camera video using image recognition AI, and for audio data, urgency, an abnormality sign, a work procedure violation, an on-site confusion situation, and the like are evaluated from a call content of an on-site worker using speech recognition AI. Specifically, the risk analysis unit deploys a large language model equipped with a self-attention mechanism on a memory. The risk analysis unit inputs a preprocessed text token sequence to the large language model. The large language model receives a character string vector such as a posted text regarding a power outage or a text representation of an equipment log as an input. The large language model outputs a classification label indicating a type of risk and a softmax value indicating a probability distribution thereof as an output. The risk analysis unit applies a time-series prediction model using a long short-term memory network to numerical data. The time-series prediction model receives a time-series array of past sensor data as an input. The time-series prediction model outputs a future predicted value and an abnormality score. The risk analysis unit applies an object detection model using a residual network to image data. The object detection model receives a color image tensor as an input. The object detection model outputs coordinates of a bounding box and a class probability. The risk analysis unit integrates these output results and calculates a comprehensive risk score. The system detects a sign of a minute abnormality that a human cannot notice at an early stage by feature amount synthesis in a high-dimensional space. The system has a technical effect of reducing a false positive rate by integrally analyzing a plurality of modalities. The system is applied to use cases such as preventive maintenance and security monitoring of a data center.

Furthermore, the generative AI performs correlation analysis by combining past failure occurrence cases or an external database (for example, a cross-industry failure case collection, a disaster database, a cyber attack incident collection, an equipment failure history, a weather disaster history, a legal regulation revision history, and the like) and currently acquired data, and quantitatively predicts a probability of risk occurrence and a degree of impact. For example, a plurality of risk occurrence scenarios are generated by referring to a case where a cooling device stopped when a typhoon approached in the past, a case where a network failure expanded in a chain reaction when a cyber attack occurred, a case where a power failure occurred simultaneously with a fire alarm, an increase in failure risk due to simultaneous occurrence of equipment aging and abnormal vibration, a large-scale failure due to a chain of human error and system failure, and the like, and collating them with a current situation. The generative AI automatically determines a risk level such as a major risk, a medium risk, and a minor risk according to a severity of the risk, prioritizes each type of risk, and also performs composite risk evaluation and chain risk evaluation when a plurality of risks occur simultaneously. Specifically, the risk analysis unit executes correlation analysis using a graph neural network. The risk analysis unit constructs a knowledge graph in which information of past failure cases and an external database is used as nodes and their relationships are used as edges. The risk analysis unit maps a feature amount vector extracted from current input data as a node feature amount on the knowledge graph. The graph neural network updates the feature amount through message passing processing between adjacent nodes. The graph neural network receives a multidimensional array such as a current equipment abnormality vector and a past weather disaster vector as an input. The graph neural network outputs a floating-point number indicating an occurrence probability of each risk scenario and a categorical variable indicating a degree of impact as an output. When the output occurrence probability exceeds a predetermined threshold, the risk analysis unit transmits the risk scenario to subsequent countermeasure planning processing. The system models a complex causal relationship as a graph structure. The system has a technical effect of dramatically improving prediction accuracy of a chain composite risk. The system is applied to use cases such as infrastructure protection and supply chain disruption prediction during a wide-area disaster.

Based on a risk determination result by the risk analysis unit, the countermeasure planning and execution unit automatically generates a plurality of optimal countermeasures according to a risk level and a type of risk while referring to past response cases, operation regulations, external guidelines, laws and regulations, contract conditions, agreements with customers, contract conditions with business partners, external best practices, disaster prevention manuals of local governments, recommended procedures of equipment manufacturers, and the like using generative AI. For example, specific action plans are automatically generated, such as “automatic activation of fire extinguishing system”, “whole building evacuation instruction”, “power cutoff”, “emergency contact to on-site person in charge”, “automatic notification to fire department”, “automatic photographing and recording of damage situation”, and “automatic monitoring of remaining amount of fire extinguishing agent” for a fire risk, “activation of emergency generator”, “load distribution”, “priority operation of important server”, “power supply switching”, “automatic contact to power company”, “UPS remaining battery level monitoring”, and “power consumption suppression instruction” for a power failure risk, “backup activation of cooling device”, “enhancement of temperature monitoring”, “on-site inspection instruction”, “switching of cooling water supply route”, “automatic cleaning of cooling tower”, and “recalculation of cooling capacity” for a cooling abnormality risk, “blocking of external connection”, “emergency notification to administrator”, “enhancement of monitoring”, “automatic saving of log”, “system isolation”, “blocking of unauthorized communication”, and “automatic application of security patch” for a cyber attack risk, “automatic switching to backup line”, “automatic contact to telecommunications carrier”, “restart of network device”, “communication load distribution”, “automatic change of network configuration”, and “resetting of communication route” for a communication failure risk, “calling attention to on-site person in charge”, “automatic distribution of work procedure manual”, “contact to on-site supervisor”, “automatic recording of work history”, “automatic warning at time of work procedure violation”, and “health condition monitoring of worker” for a human error risk, and “local evacuation instruction”, “temporary suspension of important equipment”, “automatic monitoring of on-site situation”, “cooperation with local government”, “automatic guidance of evacuation route”, and “automatic report to disaster countermeasure headquarters” for an external disaster risk. The generative AI automatically creates reports and alert notifications whose contents are optimized for each related party such as for management, for an on-site person in charge, for an operation department, for a customer, for a business partner, and for a local government, and rapidly distributes them through a management screen on a terminal side, a mobile terminal, an e-mail, a chat system, a voice call, a push notification, a wearable device, and the like. For example, a report summarizing an overall picture of a risk and key points necessary for decision-making is provided to the management, specific work instructions and a list of emergency contacts are provided to the on-site person in charge, a dashboard visualizing overall progress and a response status in real time is provided to the operation department, a notification text briefly summarizing an impact range and a response policy is provided to the customer, a notification text conveying a prospect of delivery delay and service impact is provided to the business partner, and a report summarizing an on-site situation and a response policy is provided to the local government. Specifically, the countermeasure planning and execution unit uses a generative model incorporating a reinforcement learning algorithm. The countermeasure planning and execution unit receives a risk scenario vector and a risk score output from the risk analysis unit as a state space. The generative model searches for an action sequence that maximizes an expected reward from a combination of various countermeasures defined as an action space. The generative model receives a numerical value indicating a fire risk probability and a numerical vector indicating a degree of impact level as an input. The generative model outputs structured data such as a fire extinguishing system activation command and an evacuation instruction text as an output. The countermeasure planning and execution unit inputs the generated countermeasure to a natural language generation model, and generates a report text for each related party. The natural language generation model receives a conditioning vector indicating an attribute of a target person as an input. The natural language generation model outputs a text sequence in which difficulty of technical terms and information granularity are adjusted. The system executes these processes on a parallel arithmetic processor, and derives an optimal countermeasure in a millisecond unit. The system brings about a technical effect of eliminating human judgment delay and minimizing expansion of damage. The system is applied to use cases such as automatic control of a smart building and an emergency shutdown system of a plant.

Furthermore, the countermeasure planning and execution unit automatically executes a countermeasure in cooperation with a related equipment control system and network management system for an approved countermeasure plan. For example, a fire extinguishing system is automatically activated when a fire is detected, an emergency generator is automatically activated when a power failure occurs, a backup cooling device is automatically activated when a cooling abnormality occurs, an external network connection is automatically blocked when a cyber attack occurs, automatic switching to a backup line is performed when a communication failure occurs, automatic calling attention is transmitted to an on-site person in charge when a human error occurs, and remote operation and automatic inspection of equipment, automatic photographing by an on-site camera, acquisition of position information of a worker, on-site audio recording, and the like are also automatically executed. These processes are realized by API cooperation with a building management system, a power supply control system, a cooling device management system, a network management system, a worker management system, an on-site camera system, an audio recording system, and the like. Specifically, the countermeasure planning and execution unit converts the generated countermeasure plan into a group of machine-readable control commands. The countermeasure planning and execution unit transmits the group of control commands to each equipment control system via a secure communication protocol. The countermeasure planning and execution unit outputs a digital signal for driving a relay circuit to the fire extinguishing system. The countermeasure planning and execution unit transmits a pulse signal for starting an activation sequence to the emergency generator. The countermeasure planning and execution unit issues a request for rewriting a routing table to the network management system. The countermeasure planning and execution unit receives an execution result of these control commands as a status code. When the status code indicates an error, the countermeasure planning and execution unit automatically executes a predefined fallback process. The system closely links logical judgment by software and physical control of hardware. The system realizes fully automated closed-loop control without human intervention, and has a technical effect of dramatically improving a response speed. The system is applied to use cases such as autonomous operation of an unmanned data center and management of a remote communication base station.

The progress monitoring unit monitors a progress status of all risk response processes in real time, visualizes an implementation status of each countermeasure, an unaddressed matter, a delay occurrence location, feedback from a site, occurrence of an additional risk, an on-site photo and audio record, position information of a worker, an operating status of equipment, and the like in a dashboard format, and when a response delay or an unaddressed risk is detected, transmits an automatic alert to a related party to prompt a rapid additional response. For example, when an on-site person in charge reports a damage situation with a photo from a mobile terminal, the information is immediately reflected in the entire system so that the management and the operation department can grasp the latest situation. An on-site audio record and position information of a worker are also visualized in real time to immediately grasp on-site confusion and a safety securing situation. Specifically, the progress monitoring unit receives a status update event transmitted from each equipment or terminal by an asynchronous message queue. The progress monitoring unit stores the received event data in an in-memory database to enable high-speed search and aggregation. The progress monitoring unit compares a scheduled completion time of a countermeasure with an actual progress status. The progress monitoring unit calculates a delay time in a millisecond unit. When the delay time exceeds an allowable threshold, the progress monitoring unit activates an exception handling handler. The progress monitoring unit inputs image data transmitted from the on-site person in charge to a convolutional neural network. The progress monitoring unit digitizes and outputs a degree of damage recovery as a percentage. The progress monitoring unit acquires position information of a worker as coordinate data, and maps it on a three-dimensional facility map. The system push-distributes these dynamic data to a client terminal using a bidirectional communication protocol. The system has a technical effect of enabling real-time situation grasping while minimizing redrawing of a screen. The system is applied to use cases such as a security system for a large-scale event and wide-area rescue command during a disaster.

The learning and evolution unit continuously learns new risk patterns and countermeasures using generative AI, and improves the accuracy and response capability of the entire system. For example, even for new types of cyber attacks responded to in the past, unprecedented natural disasters, new establishment of laws and regulations, new failure patterns due to aging of equipment, changes in trends of human errors, expansion of social reputational risks, and the like, the generative AI automatically expands a knowledge base and reflects it in risk prediction and countermeasure planning from the next time onward. Cooperation with external systems is also flexible, and real-time information exchange is possible with crisis management systems of other companies, cross-industry information sharing platforms, disaster prevention systems of local governments, supply chain management systems of business partners, CRM systems of customers, remote monitoring systems of equipment manufacturers, risk evaluation systems of insurance companies, and the like by API cooperation. Specifically, the learning and evolution unit dynamically updates weight parameters of a neural network using an online learning algorithm. The learning and evolution unit calculates an error between actual failure occurrence data and a risk score predicted by the system as a loss function. The learning and evolution unit calculates a gradient using an error backpropagation method, and adjusts the parameters by an optimization algorithm. The learning and evolution unit receives a packet feature vector of a new cyber attack or sensor time-series data at the time of an unknown equipment failure as an input. The learning and evolution unit outputs an updated weight matrix and bias vector of the model as an output. The learning and evolution unit applies dropout and data augmentation techniques to prevent overfitting. The learning and evolution unit uses incident data of other companies acquired from an external system as source data for transfer learning. The system autonomously acquires an adaptive capability to environmental changes by continuous model updating. The system has a technical effect of improving prediction accuracy for unknown threats over time. The system is applied to use cases such as a fraud detection system of a financial institution and a danger prediction system of an autonomous driving vehicle.

The user interface unit is mainly realized on the terminal side, and provides functions necessary for a user interface and on-site response, such as dashboard display for each related party, reception of alert notifications, input of situation reports and response statuses by an on-site person in charge, decision-making and approval operations by management, confirmation of emergency response instructions on site, voice input and image upload, automatic analysis of on-site photos, automatic transcription of on-site voices, transmission of feedback from the site, and safety monitoring of on-site workers by wearable devices. For example, an on-site person in charge reports a damage situation with a photo from a mobile terminal, or management presses an approval button for a countermeasure plan on a terminal, whereby an automatic execution process on the server side is started. Specifically, the user interface unit is constructed by adopting a single-page application architecture. The user interface unit executes differential updating of a screen at high speed using a virtual document object model. The user interface unit text-encodes image data acquired from a camera module of a mobile terminal and transmits it to the server. The user interface unit converts voice waveform data acquired from a microphone into a digital signal. The user interface unit streaming-transmits the voice data to a voice recognition model on the server side. The user interface unit detects a tap event of an approval button displayed on a terminal screen of management. The user interface unit transmits an encrypted approval token to the server triggered by the tap event. The system suppresses consumption of a network bandwidth by combining data preprocessing on the client side and asynchronous communication. The system has a technical effect of minimizing user operation delay and supporting rapid decision-making in an emergency. The system is applied to use cases such as an electronic medical record input system in a medical field and a monitoring terminal on a factory line.

The security management unit performs encryption of communication between the server and the terminal, strict management of access authority, automatic analysis of access logs and operation histories, detection of signs of unauthorized access and internal fraud, immediate alert transmission to a system administrator, multi-factorization of user authentication, encrypted storage of data, vulnerability diagnosis of the system, automatic generation of audit trails, and the like. For example, when access from an unusual time zone or location is detected, the system administrator is automatically notified, and access restriction is implemented as necessary. Specifically, the security management unit encrypts all communication paths using a transport layer security protocol. The security management unit adopts a hybrid encryption method combining a public key encryption method and a common key encryption method. The security management unit inputs time-series data of access logs to an autoencoder-type neural network. The autoencoder learns features of a normal access pattern, compresses input data into a low-dimensional latent space, and then restores it to the original dimension. The security management unit calculates a reconstruction error between the input data and the restored data. When the reconstruction error exceeds a predetermined threshold, the security management unit detects the access as an abnormality. The security management unit receives data obtained by vectorizing attributes such as an IP address, an access time, and a request URL as an input. The security management unit outputs a score between 0 and 1 indicating an abnormality probability as an output. The system mathematically detects unknown cyber attacks and internal fraud that cannot be handled by rule-based detection as geometric abnormalities in a high-dimensional data space. The system has a technical effect of minimizing an information leakage risk. The system is applied to use cases such as a confidential information management system of a government agency and transaction monitoring of a financial institution.

As described above, the data center crisis management system of the present invention is designed with depth from all perspectives, such as data collection, risk analysis, countermeasure planning and execution, progress monitoring, learning and evolution, external cooperation, user interface, and security management, and by utilizing generative AI in all processes, it is possible to detect and predict diverse risks in data center operation in real time, automate optimal responses, and significantly improve business continuity and safety. Specifically, the system operates on a distributed computing environment in which a plurality of computing nodes are connected by a high-speed network. In the system, each processing unit is independently deployed as a microservice architecture. The system dynamically scales the number of replicas of each service according to a load using a container orchestration platform. The system constructs an end-to-end processing pipeline from data collection to countermeasure execution. The system transfers data in a tensor format between the respective pipelines at high speed via a shared memory. The system lightens inference processing of a generative model using a quantization technique or a pruning technique, and enables execution on an edge device as well. The system processes a vast data stream exceeding human cognitive limits in real time. The system fundamentally improves autonomous failure recovery capability and adaptive capability of the computer system itself, rather than mere operational efficiency improvement. The system brings about technical effects of minimizing downtime and dramatically reducing operation costs. The system is applied to use cases such as an integrated management infrastructure of a smart city and an autonomous operation system of a space station.

### System Configuration

The system according to the present embodiment comprises a data collection unit, a risk analysis unit, a countermeasure planning and execution unit, a progress monitoring unit, a learning and evolution unit, an external cooperation unit, a user interface unit, and a security management unit. The data collection unit has a function of automatically acquiring real-time data from various sensors and monitoring devices such as a power system, a cooling device, security monitoring, fire detection, human monitoring, and network monitoring in a data center, and acquires, for example, operating statuses of a main power supply and an emergency generator, voltage, current, frequency, power supply switching state, remaining battery level of a UPS, and transition of power consumption from the power system, acquires cooling water pressure, refrigerant temperature, fan rotation speed, operating status of a cooling tower, abnormality alarm, and maintenance history of the cooling device from the cooling device, acquires entry/exit records, suspicious access, surveillance camera images, biometric authentication logs, patrol records of security guards, and door opening/closing histories from the security monitoring, acquires smoke detection, temperature rise, fire alarm, operating status of fire extinguishing equipment, on-site images at the time of fire occurrence, and remaining amount of fire extinguishing agent from the fire detection, acquires entry/exit of workers, work histories, suspicious person detection, health conditions of workers, work procedure compliance statuses, and qualification information of workers from the human monitoring, and acquires communication delay, packet loss, bandwidth usage rate, external connection status, signs of cyber attacks, operating statuses of network devices, and detection of unauthorized communication from the network monitoring. Furthermore, external weather information, news, SNS, disaster information, and the like are also automatically acquired through APIs, RSS, Web scraping, external cooperation services, and the like, and for example, typhoon approach, heavy rain warning, lightning strike advisory, high temperature advisory, earthquake early warning, and the like are acquired from the weather information, fire, road flooding, power outage information, traffic obstacles, and the like around the data center are acquired from the news, rumors of power outages, topics of cyber attacks, local damage photos, on-site reports of employees, and the like are acquired from the SNS, and earthquake early warning, tsunami warning, evacuation instructions, emergency contacts from local governments, and the like are acquired from the disaster information. The data collection unit automatically classifies and tags these diverse data by attributes such as time series, occurrence location, equipment type, degree of abnormality, reliability, information transmission source, data type, degree of urgency, related business area, business partner name, and customer name, and performs preprocessing such as deduplication, noise removal, reliability scoring, time-series correction of information, addition of geographic information, automatic caption generation of image data, and automatic transcription of voice data. Specifically, the data collection unit is connected to a programmable logic controller or a remote terminal unit via an industrial communication protocol. The data collection unit acquires a voltage value or a current value of a sensor as digital data at a sampling rate in units of milliseconds. The data collection unit normalizes the acquired raw data and converts it into a floating-point number within a predetermined range. The data collection unit transmits a secure request using a token-based authorization protocol to an external Web API, and acquires disaster information in a structured text format. The data collection unit inputs the acquired text data to a morphological analysis engine, and divides it into a token sequence of words. The data collection unit multiplies the token sequence by a word embedding matrix to generate a high-dimensional text feature vector. The data collection unit applies a neural network in which convolutional layers and pooling layers are alternately arranged to image data, and extracts a spatial feature map. The data collection unit uses a multimodal learning model for projecting these heterogeneous data into the same latent space. The multimodal learning model receives a numerical array of a sensor, a text vector, or an image tensor as an input. The multimodal learning model outputs an integrated context vector as an output. The system has a technical effect of absorbing differences in data formats and generating a data structure that can be uniformly processed by an artificial intelligence model in a subsequent stage. The system is applied to use cases such as an integrated monitoring system of a large-scale plant and a predictive maintenance system of a wide-area infrastructure.

The risk analysis unit has a function of analyzing a vast amount of data obtained from the data collection unit from multiple angles using generative AI, extracts keywords, phrases, emotional expressions, causal relationships, time-series changes, intentions of related parties, and the like that become risk factors from unstructured text data such as news articles, SNS posts, internal reports, and worker comments by natural language processing, automatically detects risk-related words such as “power outage risk”, “cooling abnormality”, “fire alarm”, “cyber attack”, “communication disconnection”, “equipment failure”, “human error”, and “external disaster”, for example, and estimates a type of risk, an occurrence location, and an impact range according to a context. The generative AI also performs emotion analysis and topic modeling, quantitatively evaluates signs of flaming on SNS, an increase in anxiety of on-site workers, an increase in complaints from customers, and the like, detects abnormal values and rapid changes from numerical data such as sensor data and equipment logs using pattern recognition and time-series analysis, extracts, for example, a voltage drop of a power system, a temperature rise of a cooling device, an increase in network delay, smoke detection of a fire detection system, and the like as abnormal signals, automatically determines smoke of a fire, intrusion of a suspicious person, a damage situation on site, damage to equipment, and the like from surveillance camera images using image recognition AI for image data, and evaluates urgency, signs of abnormality, work procedure violations, and the like from call contents of on-site workers using voice recognition AI for voice data. Furthermore, the generative AI performs correlation analysis by combining past failure occurrence cases or an external database and currently acquired data, quantitatively predicts a probability of risk occurrence and a degree of impact, refers to, for example, a case where a cooling device stopped when a typhoon approached in the past, a case where a network failure expanded in a chain reaction when a cyber attack occurred, a case where a power failure occurred simultaneously with a fire alarm, and the like, generates a plurality of risk scenarios by collating with a current situation, automatically determines a risk level such as a major risk, a medium risk, and a minor risk according to a severity of the risk, performs prioritization for each type of risk, and also performs composite risk evaluation and chain risk evaluation when a plurality of risks occur simultaneously. Specific examples of prompt sentences to be read by the generative AI include “Extract risk factors related to a data center from the following sensor data and external information, and predict an occurrence probability and a degree of impact”, “Generate composite risk scenarios based on the following SNS posts, weather information, and equipment logs, and list them with prioritization”, and the like. Specifically, the risk analysis unit executes a transformer-based large language model having billions of parameters on a parallel computing processor cluster. The risk analysis unit embeds the context vector output from the data collection unit into a prompt template. The risk analysis unit receives a token sequence in which numerical data such as a sensor data array or a text vector and instruction text are combined as an input. The large language model calculates an appearance probability of a next token by an autoregressive decoding process. The large language model outputs structured text such as risk factors, an occurrence probability, and a degree of impact as an output. The risk analysis unit applies a recurrent neural network equipped with an attention mechanism to time-series data. The recurrent neural network receives a past time-series window as an input, and outputs a predictive distribution of future data points. When an actual observation value deviates from a confidence interval of the predictive distribution, the risk analysis unit calculates the degree of deviation as an abnormality score. The system specializes a general-purpose language model to a specific domain by combining prompt engineering and fine-tuning. The system has a technical effect of mathematically deriving hidden causal relationships between complex events and realizing objective risk evaluation that does not depend on human intuition. The system is applied to use cases such as flight data analysis of an aircraft and systemic risk prediction of a financial market.

The countermeasure planning and execution unit has a function of automatically generating a plurality of optimal countermeasures according to a risk level and a type of risk while referring to past response cases, operation regulations, external guidelines, laws and regulations, contract conditions, agreements with customers, contract conditions with business partners, industry best practices, disaster prevention manuals of local governments, recommended procedures of equipment manufacturers, and the like using generative AI based on a risk determination result by the risk analysis unit, and automatically generates specific action plans, for example, “automatic activation of fire extinguishing system”, “whole building evacuation instruction”, “power cutoff”, “emergency contact to on-site person in charge”, “automatic notification to fire department”, and the like for a fire risk, “activation of emergency generator”, “load distribution”, “priority operation of important server”, “power supply switching”, “automatic contact to power company”, and the like for a power failure risk, “backup activation of cooling device”, “enhancement of temperature monitoring”, “on-site inspection instruction”, “switching of cooling water supply route”, and the like for a cooling abnormality risk, “blocking of external connection”, “emergency notification to administrator”, “enhancement of monitoring”, “automatic saving of log”, and the like for a cyber attack risk, “automatic switching to backup line”, “automatic contact to telecommunications carrier”, “restart of network device”, “communication load distribution”, and the like for a communication failure risk, “calling attention to on-site person in charge”, “automatic distribution of work procedure manual”, “contact to on-site supervisor”, “automatic recording of work history”, and the like for a human error risk, and “local evacuation instruction”, “temporary suspension of important equipment”, “automatic monitoring of on-site situation”, “cooperation with local government”, and the like for an external disaster risk. The generative AI automatically creates reports and alert notifications whose contents are optimized for each related party such as for management, for an on-site person in charge, for an operation department, for a customer, for a business partner, and for a local government, and rapidly distributes them through a management screen on the terminal side, a mobile terminal, an e-mail, a chat system, a voice call, a push notification, and the like. Specific examples of prompt sentences to be read by the generative AI include “Automatically generate action instructions for an on-site person in charge at the time of fire risk occurrence based on the following risk analysis result and past response cases”, “Create a summary report for management for the following risk scenario”, and the like. Furthermore, for an approved countermeasure plan, a countermeasure is automatically executed in cooperation with a related equipment control system and network management system, and for example, a fire extinguishing system is automatically activated at the time of fire detection, an emergency generator is automatically activated at the time of power failure, a backup cooling device is automatically activated at the time of cooling abnormality, an external network connection is automatically blocked at the time of cyber attack, automatic switching to a backup line is performed at the time of communication failure, and automatic calling of attention to an on-site person in charge is transmitted at the time of human error. Specifically, the countermeasure planning and execution unit adopts a retrieval-augmented generation architecture. The countermeasure planning and execution unit searches a vector database using the risk scenario vector output from the risk analysis unit as a query. In the vector database, past response cases and operation regulations are stored as dense vectors. The countermeasure planning and execution unit extracts a highly relevant document vector based on cosine similarity. The countermeasure planning and execution unit combines the extracted document text and the risk scenario to construct an input prompt to a large language model. The large language model receives a text token sequence such as a risk scenario and related regulations as an input. The large language model outputs a specific command sequence and notification text for related parties as an output. The countermeasure planning and execution unit parses the output command sequence and converts it into a communication payload for each equipment control system. The countermeasure planning and execution unit transmits the payload to a fire extinguishing system or a power supply control system via a communication protocol. The system has a technical effect of suppressing hallucination of a model and generating an accurate countermeasure based on facts by dynamically incorporating external knowledge. The system is applied to use cases such as an emergency avoidance system of an autonomous driving vehicle and a triage support system of a medical institution.

The progress monitoring unit monitors progress statuses of all risk response processes in real time, visualizes implementation statuses of respective countermeasures, unaddressed items, delay occurrence locations, feedback from a site, occurrence of additional risks, on-site photos and voice records, position information of workers, operating statuses of equipment, and the like in a dashboard format, and when a response delay or an unaddressed risk is detected, transmits an automatic alert to related parties to prompt a rapid additional response. For example, when an on-site person in charge reports a damage situation with a photo from a mobile terminal, the information is immediately reflected in the entire system so that management and an operation department can grasp the latest situation. Voice records on site and position information of workers are also visualized in real time to immediately grasp confusion on site and a safety securing situation. Specifically, the progress monitoring unit adopts an event-driven architecture and uses a distributed messaging system. The progress monitoring unit subscribes to status logs published from respective subsystems in real time. The progress monitoring unit executes aggregation and filtering of events within a moving window using a stream processing engine. The progress monitoring unit compares a timeout value set for each step of a countermeasure with a current time. The progress monitoring unit specifies a step that has exceeded the timeout, and outputs an identifier and a delay time of the step as an error log. The progress monitoring unit acquires latitude and longitude data of GPS coordinates transmitted from a mobile terminal of an on-site person in charge. The progress monitoring unit collates the latitude and longitude data with three-dimensional building information modeling data of a facility to specify an accurate spatial position of a worker. The progress monitoring unit transmits these processing results as a structured data payload to a front-end application. The system has a technical effect of processing a large amount of asynchronous events without delay and maintaining state consistency of the entire system. The system is applied to use cases such as robot control monitoring of a large-scale logistics center and distribution network monitoring of a smart grid.

The learning and evolution unit has a function of continuously learning new risk patterns and countermeasures using generative AI, and improving the accuracy and response capability of the entire system, and for example, even for new types of cyber attacks responded to in the past, unprecedented natural disasters, new establishment of laws and regulations, new failure patterns due to aging of equipment, changes in trends of human errors, expansion of social reputational risks, and the like, the generative AI automatically expands a knowledge base and reflects it in risk prediction and countermeasure planning from the next time onward. Specific examples of prompt sentences to be read by the generative AI include “Learn the following failure response history and update an optimal countermeasure pattern at the time of cooling device abnormality in the future”, “Analyze past cyber attack cases and countermeasures, and automatically generate countermeasures for new attack patterns”, and the like. Specifically, the learning and evolution unit implements a continuous learning framework. The learning and evolution unit accumulates pairs of newly collected incident data and response results as a learning data set. The learning and evolution unit holds past important learning data in a replay buffer in order to prevent catastrophic forgetting. The learning and evolution unit creates a mini-batch in which new data and data in the replay buffer are mixed. The learning and evolution unit inputs the mini-batch to a neural network, performs forward propagation calculation, and outputs a predicted value. The learning and evolution unit calculates a cross-entropy error between the predicted value and a correct label. The learning and evolution unit calculates a weight gradient of each layer by an error backpropagation method, and updates a weight using an optimization algorithm based on a gradient descent method. The learning and evolution unit receives log text of a new cyber attack or a binary label indicating success or failure of a countermeasure as an input. The learning and evolution unit outputs a checkpoint file of updated model parameters as an output. The system has a technical effect of improving inference accuracy of a model as operation continues, and enhancing self-healing capability of the system against unknown threats. The system is applied to use cases such as automatic updating of a malware detection engine and operation optimization of an industrial robot.

The external cooperation unit has a function of exchanging information in real time with a crisis management system of another company, a cross-industry information sharing platform, a disaster prevention system of a local government, a supply chain management system of a business partner, a CRM system of a customer, a remote monitoring system of an equipment manufacturer, a risk evaluation system of an insurance company, and the like by API cooperation, and for example, automatically acquires disaster information from a local government, automatically receives delivery delay information from a business partner, automatically reflects an alert from an industry group, and automatically analyzes inquiry contents from a customer. Specifically, the external cooperation unit functions as an API gateway that mediates communication between microservices. The external cooperation unit supports a plurality of communication protocols with an external system. The external cooperation unit executes a data mapping process of converting data in a comma-separated text format received from an external system into a structured text format standardized inside the system. The external cooperation unit implements a retry mechanism with exponential backoff in order to ensure reliability of communication. The external cooperation unit acquires numerical and text data such as a seismic intensity and an epicenter from a disaster prevention system of a local government. The external cooperation unit acquires integer value data such as the number of parts in stock and a delivery delay time from a supply chain management system of a business partner. The external cooperation unit stores these acquired data in a distributed cache on a memory, and enables high-speed reading from other processing units. The system has a technical effect of eliminating data silos in a heterogeneous environment and realizing seamless data integration across organizational boundaries. The system is applied to use cases such as dynamic optimization of a smart supply chain and a wide-area medical cooperation network.

The user interface unit is mainly realized on the terminal side, and provides functions necessary for a user interface and an on-site response, such as dashboard display for each related party, reception of an alert notification, input of a status report and a response status by an on-site person in charge, decision-making and approval operation by management, confirmation of an emergency response instruction at a site, voice input and image upload, automatic analysis of an on-site photograph, automatic transcription of an on-site voice, transmission of feedback from a site, and safety monitoring of an on-site worker by a wearable device. For example, an on-site person in charge reports a damage situation with a photograph from a mobile terminal, or management presses an approval button of a countermeasure plan on a terminal, whereby an automatic execution process on the server side is started. Specifically, the user interface unit executes high-speed data processing on the client side using a binary instruction format for a browser. The user interface unit renders a large amount of time-series data points received from the server using a parallel arithmetic processor on the client side, and realizes smooth graph drawing. The user interface unit acquires raw data from an acceleration sensor and a heart rate sensor built in a wearable device via a short-range wireless communication protocol. The user interface unit applies a low-pass filter to the acquired raw data, and generates a feature vector from which noise is removed. The user interface unit inputs the feature vector to an edge artificial intelligence model, and locally determines a fall or an abnormal stress state of a worker. When detecting an abnormality, the user interface unit immediately transmits an alert payload to the server. The user interface unit inputs on-site voice data to a local lightweight voice recognition model, converts the voice data into a text token, and then transmits the text token to the server, thereby saving a communication band. The system has a technical effect of optimally sharing edge computing and cloud computing and improving a response speed and scalability of the entire system. The system is applied to use cases such as a safety management system at a construction site and patient monitoring in telemedicine.

The security management unit performs encryption of communication between the server and the terminal, strict management of access authority, automatic analysis of an access log and an operation history, detection of a sign of unauthorized access or internal fraud, transmission of an immediate alert to a system administrator, multi-factorization of user authentication, encrypted storage of data, vulnerability diagnosis of the system, automatic generation of an audit trail, and the like. For example, when detecting access from an unusual time zone or location, the security management unit automatically notifies the system administrator, and implements an access restriction as necessary. Specifically, the security management unit executes dynamic context evaluation for all access requests based on a zero trust architecture. The security management unit inputs not only user authentication information but also a multidimensional attribute vector such as a security state of a device, a network location, and an access time to an evaluation engine. The evaluation engine classifies the attribute vector using a random forest algorithm, and outputs a binary value indicating whether or not access is permitted. The security management unit encrypts confidential data stored in a database in units of blocks using an advanced encryption standard algorithm. The security management unit securely manages a life cycle of an encryption key in a hardware security module. The security management unit periodically executes an automated penetration test tool as a vulnerability diagnosis of the system. The security management unit inputs an output from the test tool to a natural language processing model, and automatically calculates a score indicating a severity of a vulnerability. The system has a technical effect of implementing multi-layered security control independent of boundary defense as arithmetic processing inside a computer, and mathematically minimizing an information leakage risk. The system is applied to use cases such as protection of a cloud-native application and defense of a military communication network.

As described above, the system according to the present embodiment is configured with depth from all perspectives such as data collection, risk analysis, countermeasure planning and execution, progress monitoring, learning and evolution, external cooperation, user interface, and security management, and by utilizing generative AI in all processes, it is possible to detect and predict diverse risks in data center operation in real time, automate an optimal response, and significantly improve business continuity and safety. Specifically, the system is configured as a distributed system in which each processing unit is containerized and autonomously managed on a container orchestration platform. The system controls a data flow from data collection to countermeasure execution by a workflow engine defined as a directed acyclic graph. The system asynchronously passes a processing result at each node to a next node in a tensor format. In inference processing of a generative artificial intelligence model, the system parallelizes a matrix multiplication operation using hardware specialized for a tensor operation, and maximizes throughput. The system automatically executes a continuous integration and continuous delivery pipeline for periodically updating a weight parameter of the model. The system seamlessly integrates physical control of hardware and logical inference of software without requiring human intervention. The system brings about a technical improvement of deriving an optimal solution based on probabilistic inference in a high-dimensional space in units of milliseconds for an unknown composite risk that cannot be handled by a conventional rule-based system. The system is applied to advanced use cases such as a next-generation completely unmanned data center and an autonomous control system of a deep space probe.

### Implementation Steps

Step 1: Real-time collection of multidimensional information In this step, real-time data such as an operating status of a main power supply and an emergency generator, a voltage, a current, a frequency, a power supply switching state, a UPS battery remaining amount, a cooling water pressure, a refrigerant temperature, a fan rotation speed, an entry/exit record, unauthorized access, a surveillance camera image, a biometric authentication log, smoke detection, a temperature rise, a fire alarm, an operating status of fire extinguishing equipment, entry/exit, a work history, and a health condition of a worker, a communication delay, a packet loss, a bandwidth usage rate, and a sign of a cyber attack are automatically acquired from various sensors and monitoring devices such as a power system, a cooling device, security monitoring, fire detection, human monitoring, and network monitoring in a data center, and furthermore, external weather information, news, SNS, disaster information, and the like are also automatically acquired through an API, RSS, Web scraping, an external cooperation service, and the like, and these diverse data are automatically classified and tagged by attributes such as time series, occurrence location, equipment type, degree of abnormality, reliability, information transmission source, data type, degree of urgency, and related business area, and preprocessing such as deduplication, noise removal, reliability scoring, time-series correction of information, addition of geographic information, automatic caption generation of image data, and automatic transcription of voice data is performed. Specifically, the system constructs a data collection module using an arithmetic server group including a plurality of processors and a large-capacity memory. The system receives stream data asynchronously transmitted from thousands of IoT sensors arranged in the data center. The system temporarily stores the received data in a ring buffer on a memory. The system acquires a voltage value and a current value from a sensor of the power system as a one-dimensional floating-point number array. The system acquires a refrigerant temperature and a fan rotation speed from a sensor of the cooling device as a time-series numerical vector. The system divides video data acquired from a surveillance camera for each frame. The system converts the divided image frame into a color image tensor of 224 pixels vertically, 224 pixels horizontally, and 3 channels. The system acquires external weather information and news text via an API. The system inputs the acquired text data to a natural language processing engine. The system divides the text data into word tokens. The system converts the divided tokens into a 768-dimensional embedding vector. The system synchronizes these heterogeneous data based on a common time stamp. The system integrates the synchronized data as a multimodal feature matrix. The system executes a missing value imputation algorithm as preprocessing of data. The system removes noise of sensor data using a Kalman filter. The system applies contrast enhancement processing to image data. The system executes a fast Fourier transform on voice data, and generates a frequency spectrogram. The system equalizes the quality of data by these preprocessings. The system transfers the preprocessed high-dimensional tensor data to a risk analysis module in a subsequent stage. The system dramatically improves inference accuracy of a subsequent artificial intelligence model by this data integration and preprocessing. The system significantly reduces a calculation load of the entire system by discarding unnecessary noise data at an early stage. The system optimizes bandwidth consumption of a communication network. The system completely eliminates manual data collection work by a human. The system processes a vast amount of data at a speed exceeding human cognitive limits. The system exhibits an extremely high technical effect in use cases such as infrastructure monitoring of a data center and abnormality detection of a large-scale manufacturing plant.
Step 2: Extraction and analysis of risk factors by generative AI In this step, generative AI is used. The generative AI extracts keywords, phrases, emotional expressions, causal relationships, time-series changes, intentions of related parties, and the like that become risk factors from unstructured text data such as news articles, SNS posts, internal reports, and worker comments by natural language processing, also performs emotion analysis and topic modeling, quantitatively evaluates a sign of flaming on SNS, an increase in anxiety of an on-site worker, an increase in complaints from customers, and the like, detects an abnormal value and a rapid change from numerical data such as sensor data and an equipment log using pattern recognition and time-series analysis, automatically determines smoke of a fire, intrusion of a suspicious person, a damage situation of a site, damage to equipment, and the like from a surveillance camera video using image recognition AI, and evaluates urgency, an abnormality sign, a work procedure violation, and the like from call contents of an on-site worker using voice recognition AI. Specific examples of a prompt sentence to be read by the generative AI include “Extract risk factors related to a data center from the following sensor data and external information, and predict a probability of occurrence and a degree of impact”, “Generate a composite risk scenario based on the following SNS posts, weather information, and equipment logs, and list them with priorities”, and the like. Specifically, the system deploys a large language model equipped with an attention mechanism and a convolutional neural network on a memory. The system inputs the preprocessed multimodal feature matrix to an artificial intelligence model. The system inputs, for example, a typhoon approach alert of the Meteorological Agency, a post regarding a power outage on SNS, and an internal equipment inspection report as text data. The system inputs these texts to the model as a token embedding vector of thousands of dimensions. The system inputs, for example, a smoke emission image, an intrusion image of a suspicious person, and a damage image of equipment captured by a surveillance camera as image data. The system inputs these images to the model as a multidimensional pixel value tensor. The system inputs, for example, a temperature transition of a server rack, a pressure change of cooling water, and a packet loss rate of a network as numerical data. The system inputs these numerical values to the model as a time-series floating-point number array. The system executes inference processing of the artificial intelligence model. The system generates a risk score, a probability distribution of a risk category, and an extracted feature vector as an output of the model. The system outputs a floating-point number such as 0.95, 0.82, and 0.45 as the risk score. The system outputs a probability distribution such as a fire occurrence probability of 80 percent, a cyber attack probability of 15 percent, and an equipment failure probability of 5 percent as the risk category. The system outputs, for example, a smoke emission sign vector, an abnormal vibration vector, and an unauthorized access vector as the extracted feature amount. The system transmits these output results to a subsequent scenario generation module. The system triggers subsequent advanced analysis processing only when the output risk score exceeds a predetermined threshold value. The system prevents wasteful consumption of calculation resources by this threshold value determination. The system discovers a minute abnormality sign unnoticed by a human at an early stage by feature extraction in a high-dimensional space. The system identifies an unknown risk factor that cannot be handled by a conventional rule-based abnormality detection system. The system dramatically reduces a failure occurrence rate of a data center by this processing. The system exhibits an extremely high technical effect in use cases such as system monitoring of a financial institution and protection of critical infrastructure.
Step 3: Risk scenario generation and risk level determination The generative AI performs correlation analysis by combining past failure occurrence cases or an external database and currently acquired data, quantitatively predicts a probability of risk occurrence and a degree of impact, refers to a case where a cooling device stopped when a typhoon approached in the past, a case where a network failure expanded in a chain reaction when a cyber attack occurred, a case where a power failure occurred simultaneously with a fire alarm, and the like, generates a plurality of risk scenarios by collating with a current situation, automatically determines a risk level such as a major risk, a medium risk, and a minor risk according to a severity of the risk, performs prioritization for each type of risk, and also performs composite risk evaluation and chain risk evaluation when a plurality of risks occur simultaneously. Specific examples of a prompt sentence to be read by the generative AI include “Generate a composite risk scenario based on the following sensor data, external information, and past failure cases, and evaluate a probability of occurrence and a degree of impact of each”, “Analyze a composite risk when a plurality of risk factors occur simultaneously, and list them with priorities”, and the like. Specifically, the system deploys a correlation analysis module using a graph neural network on a memory. The system inputs the extracted risk feature vector group and a case embedding vector acquired from a past failure case database to a model. The system inputs, for example, a feature vector indicating a current temperature rise, a vector of a past cooling device failure case, and a feature vector indicating a current network delay as input data. The system arranges these vectors in a multidimensional space. The system calculates a cosine similarity and an inner product between the vectors. The system learns a hidden correlation between different data sources using a cross-modal attention mechanism. The system generates a generation probability score and an impact degree matrix of a plurality of risk scenarios as an output of the model. The system outputs a floating-point number such as 0.88 for scenario A, 0.65 for scenario B, and 0.32 for scenario C as the generation probability score. The system outputs structured data such as a system stop time of 120 minutes, a data loss amount of 50 gigabytes, and a recovery cost of 1 million yen as the impact degree matrix. The system automatically classifies the risk level based on these output results. The system determines, for example, a case where a product of the generation probability score and the degree of impact exceeds a predetermined threshold value as a major risk. The system transfers the determined risk level and the generated scenario data to a subsequent countermeasure planning module. The system accurately predicts a composite chain risk that cannot be detected by a single sensor by this correlation analysis. The system eliminates a judgment depending on a rule of thumb by a human. The system completes collation with a vast amount of past cases in units of milliseconds by a vector operation in a high-dimensional space. The system enables a proactive response before a failure occurs by this improvement in processing speed. The system exhibits an extremely high technical effect in use cases such as operation management of a large-scale cloud infrastructure and a disaster prevention system of a smart city.
Step 4: Automatic planning and optimization of countermeasures by generative AI Based on a risk determination result by the risk analysis unit, a plurality of optimal countermeasures according to a risk level and a type of risk are automatically generated using generative AI while referring to past response cases, operation regulations, external guidelines, laws and regulations, contract conditions, agreements with customers, contract conditions with business partners, industry best practices, disaster prevention manuals of local governments, recommended procedures of equipment manufacturers, and the like. For example, specific action plans are automatically generated, such as “automatic activation of fire extinguishing system”, “whole building evacuation instruction”, “power cutoff”, “emergency contact to on-site person in charge”, and “automatic report to fire department” for a fire risk, “activation of emergency generator”, “load distribution”, “priority operation of important server”, “power supply switching”, and “automatic contact to power company” for a power failure risk, “backup activation of cooling device”, “enhancement of temperature monitoring”, “on-site inspection instruction”, and “switching of cooling water supply route” for a cooling abnormality risk, “blocking of external connection”, “emergency report to administrator”, “enhancement of monitoring”, and “automatic saving of log” for a cyber attack risk, “automatic switching to backup line”, “automatic contact to telecommunications carrier”, “restart of network equipment”, and “communication load distribution” for a communication failure risk, “calling attention to on-site person in charge”, “automatic distribution of work procedure manual”, “contact to on-site supervisor”, and “automatic recording of work history” for a human error risk, and “local evacuation instruction”, “temporary suspension of important equipment”, “automatic monitoring of on-site situation”, and “cooperation with local government” for an external disaster risk. Specific examples of a prompt sentence to be read by the generative AI include “Automatically generate an action instruction for an on-site person in charge when a fire risk occurs based on the following risk analysis result and past response cases”, “Create a summary report for management for the following risk scenario”, and the like. Specifically, the system deploys a countermeasure planning module combining a reinforcement learning algorithm and a constrained generative model on a memory. The system inputs a risk level vector, a scenario embedding vector, and a resource constraint matrix to the model. The system inputs, for example, a one-hot vector indicating a major risk, a 768-dimensional vector indicating a composite scenario of a fire and a power outage, and a numerical matrix indicating the number of currently operable emergency generators and the number of waiting workers as input data. The system searches for an optimal procedure from a vast combination of countermeasures using a beam search algorithm. The system generates an execution procedure list of countermeasures and a success probability score of each countermeasure as an output of the model. The system outputs a command array such as an emergency generator activation command for step 1, a shutdown command of a specific server for step 2, and a fire extinguishing equipment operation command for step 3 as the execution procedure list. The system outputs a floating-point number such as 0.92, 0.85, and 0.78 as the success probability score. The system transmits these output results to a subsequent report generation module and automatic execution module. The system converts the output command array into a machine-readable format. The system minimizes a recovery time under a limited resource condition by this optimization processing. The system calmly and logically derives an optimal action plan even in an emergency where a human falls into a panic state. The system realizes optimal allocation of computer resources. The system exhibits an extremely high technical effect in use cases such as abnormality response of an automatic piloting system of an aircraft and emergency control of a nuclear power plant.
Step 5: Automatic generation and distribution of reports and alerts by related party The generative AI automatically creates reports and alert notifications whose contents are optimized for each related party such as for management, for an on-site person in charge, for an operation department, for a customer, for a business partner, and for a local government, and rapidly distributes them through a management screen on the terminal side, a mobile terminal, an e-mail, a chat system, a voice call, a push notification, and the like. For example, a report summarizing an overall picture of a risk and essential points necessary for decision-making is provided to management, a specific work instruction and an emergency contact list are provided to an on-site person in charge, a dashboard visualizing overall progress and a response status in real time is provided to an operation department, a notification text briefly summarizing an impact range and a response policy is provided to a customer, a notification text conveying a prospect of a delivery delay and a service impact is provided to a business partner, and a report summarizing an on-site situation and a response policy is provided to a local government. Specific examples of a prompt sentence to be read by the generative AI include “Automatically generate a summary report for management based on the following countermeasures”, “Automatically generate a specific action instruction for an on-site person in charge”, “Create a notification text briefly summarizing an impact range and a response policy for a customer”, and the like. Specifically, the system deploys a report generation module equipped with a natural language generation model and a template synthesis engine on a memory. The system inputs a countermeasure command array and a target person profile vector to the model. The system inputs, for example, a command array of emergency generator activation, a numerical vector indicating an authority level of management, and a feature vector indicating a skill set of an on-site worker as input data. The system dynamically adjusts a level of technical terms and an information amount of an output text according to an attribute of a target person. The system generates text data for each target person, an importance flag, and distribution protocol designation data as an output of the model. The system outputs, for example, a summary text including a predicted value of a total damage amount for management, and a detailed text including a specific valve operation procedure for an on-site worker as the text data. The system outputs categorical data such as critical, high, medium, and low as the importance flag. The system outputs a communication protocol identifier such as SMTP, HTTPS, and MQTT as the distribution protocol designation data. The system transmits these output results to a subsequent communication interface. When the importance flag is critical, the system allocates a highest priority communication band and transmits a packet. The system minimizes a delay in information transmission by this dynamic generation processing. The system reduces a load on a communication network by suppressing unnecessary information transmission. The system completely substitutes manual report creation and operation of a contact network by a human. The system exhibits an extremely high technical effect in use cases such as a wide-area evacuation guidance system at the time of a large-scale disaster and a global crisis management network of a multinational corporation.
Step 6: Automatic Countermeasure Execution and Progress Monitoring For an approved countermeasure plan, the countermeasure planning and execution unit automatically executes a countermeasure in cooperation with a related equipment control system and network management system, for example, automatically activates a fire extinguishing system upon fire detection, automatically activates an emergency generator upon power failure, automatically activates a backup cooling device upon cooling abnormality, automatically blocks an external network connection upon cyber attack, automatically switches to a backup line upon communication failure, transmits an automatic alert to an on-site person in charge upon human error, and also automatically executes remote control and automatic inspection of equipment, automatic photographing by an on-site camera, acquisition of position information of a worker, and voice recording of a site. A progress monitoring unit monitors a progress status of all risk response processes in real time, visualizes an implementation status of each countermeasure, an unaddressed item, a delay occurrence location, feedback from the site, occurrence of an additional risk, a site photograph and voice recording, position information of a worker, an operation status of equipment, and the like in a dashboard format, and when a response delay or an unaddressed risk is detected, transmits an automatic alert to a related party to prompt a prompt additional response. Specifically, the system deploys an execution management module cooperating with a distributed control system on a memory. The system inputs a countermeasure command array and a real-time equipment status vector to the module. The system inputs, as input data, for example, an emergency generator activation command, a floating-point number indicating a current main power supply voltage value, and a binary array indicating a port state of a network switch. The system generates a unique control signal packet for each hardware device based on these inputs. The system generates a control packet for a programmable logic controller, an API request for an IoT gateway, and a progress status code as outputs of the model. The system outputs, as the control packet, for example, hexadecimal binary data for opening a specific valve. The system outputs, as the API request, for example, a payload in JSON format for changing a routing setting of a router. The system outputs, as the progress status code, for example, state transition data such as executing, completed, and error. The system transmits these output results to a target device. The system receives a response signal from the device. When the response signal indicates an error, the system immediately recalculates an alternative countermeasure command. The system ensures reliable operation of hardware by this feedback control. The system shortens a response time to a millisecond unit by directly controlling a physical device without human intervention. The system realizes autonomous stabilization of the entire system. The system exhibits an extremely high technical effect in use cases such as autonomous operation of an unmanned data center and an automatic recovery system of a smart factory.
Step 7: System Accuracy Improvement by Learning and Evolution A learning and evolution unit continuously learns a new risk pattern and countermeasure using generative AI, and improves accuracy and response capability of the entire system. For example, even for a new type of cyber attack or an unprecedented natural disaster responded to in the past, establishment of a new law or regulation, a new failure pattern due to aging of equipment, a change in a tendency of human error, expansion of a social reputational risk, and the like, the generative AI automatically expands a knowledge base and reflects it in risk prediction and countermeasure planning from the next time onward. Specific examples of a prompt sentence to be read by the generative AI include “Learn the following failure response history and update an optimal countermeasure pattern at the time of cooling device abnormality in the future” and “Analyze past cyber attack cases and countermeasures and automatically generate a countermeasure against a new attack pattern”. Specifically, the system deploys a learning module equipped with an online learning algorithm and an experience replay buffer on a memory. The system inputs feedback data of an execution result and a state tensor at the time of prediction to a model. The system inputs, as input data, for example, a binary label indicating success or failure of a countermeasure, numerical data indicating a time taken for recovery, and a multimodal feature matrix used at the time of prediction. The system calculates a difference between the time of prediction and an actual result. The system defines a cross-entropy error or a mean square error as a loss function. The system calculates a gradient of a neural network using an error backpropagation method. The system generates an updated weight parameter matrix and bias vector as outputs of the model. The system outputs, as the weight parameter matrix, for example, a multidimensional tensor consisting of millions of floating-point numbers. The system outputs, as the bias vector, a numerical array for adjusting an activation threshold of each neuron. The system dynamically updates a model parameter of a production environment using these output results. The system immediately applies the updated parameter from the next inference cycle. The system dramatically improves adaptability of the system to secular change of an environment and an unknown threat by this continuous learning process. The system continuously reduces an inference error in long-term operation. The system completely eliminates manual model tuning work by a human. The system exhibits an extremely high technical effect in use cases such as a cyber security threat intelligence system and a driving data learning platform of an autonomous driving vehicle.

### Specific Use Case

For example, in an operation site of a data center, a situation is assumed in which a plurality of risk factors occur superimposedly at the same time as a typhoon approaches. A data collection unit automatically acquires a course prediction of a typhoon and a heavy rain warning from weather information, and simultaneously acquires information such as a voltage drop of a main power supply and an operation status of an emergency generator from a power system, a rise in refrigerant temperature and a drop in cooling water pressure from a cooling device, an abnormal value of a smoke detection sensor from fire detection, an increase in communication delay and packet loss from network monitoring, an increase in suspicious access from security monitoring, detection of a health condition abnormality of an on-site worker and a work procedure violation from human monitoring, posts such as “rumor of data center power outage” and “local inundation photograph” from SNS, and “large-scale power outage occurrence in surrounding area” and “traffic obstacle due to road flooding” from news. These diverse data are automatically classified and tagged by attributes such as time series, occurrence location, equipment type, degree of abnormality, reliability, information source, and degree of urgency, and noise removal and reliability scoring are also executed. Specifically, the system deploys a high-speed data collection module using multi-thread processing on a memory. The system receives asynchronous multimodal data streams in parallel. The system inputs, as input data, for example, course prediction data in JSON format from a weather API, a voltage value array with a period of 100 milliseconds from a power sensor, and a multidimensional vector of temperature and pressure from a cooling device. The system further inputs text data acquired from SNS to a natural language processing model, and converts it into a 768-dimensional embedding vector. The system inputs an inundation image acquired from SNS to a convolutional neural network, and converts it into a 2048-dimensional image feature vector. The system synchronizes these heterogeneous data with a common time stamp. The system integrates the synchronized data as a huge multimodal feature matrix. The system generates a normalized feature tensor and a reliability score of each data as outputs of the model. The system outputs, as the feature tensor, for example, a high-dimensional floating-point number array having more than 10,000 dimensions. The system outputs, as the reliability score, for example, a numerical value such as 0.99 for Meteorological Agency data and 0.45 for an anonymous SNS post. The system transfers these output results to a subsequent risk analysis unit in a batch or stream format. The system filters data whose reliability score falls below a predetermined threshold. The system dramatically improves calculation efficiency of subsequent analysis processing by this data integration and filtering. The system prevents false detection due to mixing of noise data. The system exhibits an extremely high technical effect in use cases such as composite disaster monitoring of a large-scale plant and real-time monitoring of wide-area infrastructure.

Using generative AI, the risk analysis unit extracts risk factors such as “power outage”, “inundation”, “traffic obstacle”, and “equipment abnormality” from SNS posts and news articles by natural language processing, detects abnormal values such as voltage drop, cooling abnormality, smoke detection, and communication delay from sensor data by pattern recognition and time-series analysis, automatically determines signs of inundation and equipment damage from on-site camera images by image recognition AI, and evaluates urgency and confusion status from call contents of on-site workers by voice recognition AI. Furthermore, the risk analysis unit generates a composite risk scenario by collating past failure occurrence cases, cooling device stop cases, emergency generator switching failure cases, on-site response delay cases due to traffic obstacles, and the like at the time of typhoon disasters with an external database. For example, the risk analysis unit presents a scenario such as “when a typhoon approach and a main power supply voltage drop occur simultaneously, there is a high risk that an emergency generator switching delay, a cooling device stop, a communication failure, and an on-site worker evacuation delay will occur in a chain reaction”, and performs level determination and prioritization of a major risk, a medium risk, and a minor risk. Specifically, the system deploys a deep learning model equipped with a cross-modal attention mechanism on a memory. The system inputs a normalized feature tensor and an embedding vector of a past case to the model. The system inputs, as input data, for example, a power outage risk vector extracted from SNS text, a voltage drop vector extracted from sensor data, and an inundation sign vector extracted from a camera image. The system calculates an inner product between these vectors, and generates an attention weight matrix. The system quantifies a hidden correlation between different modalities using this weight matrix. The system generates a fused risk representation vector and a probability score for each scenario as outputs of the model. The system outputs, as the risk representation vector, for example, a 512-dimensional high-density floating-point number array. The system outputs, as the probability score, for example, a numerical value such as an occurrence probability of 0.87 for a chain failure scenario and an occurrence probability of 0.34 for a single equipment failure scenario. The system transmits these output results to a subsequent countermeasure planning unit. The system automatically classifies a risk level into three stages of major, medium, and minor based on the probability score. The system accurately predicts a composite risk that is overlooked by a single data source by this feature fusion in a high-dimensional space. The system eliminates intuitive judgment by a human, and realizes objective risk evaluation based on pure mathematical calculation. The system prevents a fatal system down by dramatically improving prediction accuracy. The system exhibits an extremely high technical effect in use cases such as failure prediction of a financial trading system and abnormality detection of a traffic control system.

Using generative AI, the countermeasure planning and execution unit automatically generates a plurality of specific countermeasures such as “immediate activation of emergency generator”, “automatic activation of cooling device backup”, “whole building evacuation instruction”, “transition to standby mode of fire extinguishing system”, “emergency contact to on-site worker”, “alternative route guidance at time of traffic obstacle”, “service impact notification to customer”, and “automatic report of site situation to local government” while referring to past typhoon disaster response cases, recommended procedures of equipment manufacturers, disaster prevention manuals of local governments, operation regulations, contract conditions, and the like. Furthermore, the countermeasure planning and execution unit automatically generates reports and alert notifications optimized for each related party, such as “report summarizing overall risk and decision-making points” for management, “safety securing procedure at site and emergency contact list” for an on-site person in charge, “dashboard of progress status and unaddressed items” for an operation department, “notification text of service impact and recovery prospect” for a customer, and “report of site situation and response policy” for a local government, and distributes them through a terminal, an email, a chat system, a push notification, and the like. Specifically, the system deploys an optimization algorithm for solving a constraint satisfaction problem and a natural language generation model on a memory. The system inputs a fused risk representation vector and a resource constraint matrix to the model. The system inputs, as input data, for example, a 512-dimensional vector indicating a chain failure risk, numerical data indicating a capacity of a currently available backup power supply, and a coordinate matrix indicating an arrangement status of on-site workers. The system evaluates a combination of executable countermeasures in a search space based on these inputs. The system generates optimized countermeasure sequence data and notification text data for each target person as outputs of the model. The system outputs, as the countermeasure sequence data, for example, an ordered command array such as step 1 being generator activation, step 2 being cooling device switching, and step 3 being evacuation instruction. The system outputs, as the notification text data, for example, a summary character string for management and a specific procedure character string for a site. The system transmits these output results to a subsequent execution management unit and communication interface. The system packetizes the generated text data according to a specified protocol. The system derives an optimal solution under limited resources at high speed by this optimization processing. The system significantly shortens a system recovery time. The system completely eliminates human communication errors by automating information transmission to related parties. The system exhibits an extremely high technical effect in use cases such as a disaster response system of a large-scale hospital and emergency reconstruction of a logistics network.

For an approved countermeasure plan, an execution management unit automatically executes automatic activation of an emergency generator and a cooling device in cooperation with an equipment control system, transition to a standby mode of a fire extinguishing system, automatic switching of a communication path in cooperation with a network management system, automatic photographing by an on-site camera, acquisition of position information of a worker, on-site voice recording, and the like. A progress monitoring unit visualizes a progress status of all risk response processes, an unaddressed item, a delay occurrence location, feedback from a site, occurrence of an additional risk, a site photograph and voice recording, position information of a worker, an operation status of equipment, and the like in a dashboard format, and when a response delay or an unaddressed risk is detected, transmits an automatic alert to a related party to prompt a prompt additional response. Specifically, the system deploys an execution control module equipped with a distributed transaction management function on a memory. The system inputs optimized countermeasure sequence data and a current state vector of each device to the module. The system inputs, as input data, for example, a generator activation command array, a binary vector indicating a current operation state of a cooling device, and a current routing table of a network router. The system simulates an impact of execution of each command on the entire system using a state transition model. The system generates a device-specific control protocol packet and progress status update data as outputs of the model. The system outputs, as the control protocol packet, for example, a hexadecimal control command compliant with a Modbus protocol. The system outputs, as the progress status update data, for example, an integer value from 0 to 100 indicating a completion rate of each task. The system transmits these output results to a target hardware device and a dashboard rendering engine. The system receives an Ack signal from the device, and executes commit or rollback of a transaction. The system ensures reliable execution of commands for a plurality of devices by this distributed control. The system distributes a network load, and avoids an uncontrollable state due to a single point of failure. The system dramatically improves a situation grasping speed of a system administrator by real-time visualization. The system exhibits an extremely high technical effect in use cases such as power grid control of a smart grid and robot control of an automated huge warehouse.

Using generative AI, a learning and evolution unit accumulates an entire process of this typhoon disaster response, an initial response at the time of equipment abnormality and its effect, a reaction to a service impact notification to a customer, an evacuation behavior history of an on-site worker, and the like as learning data, and reflects them in accuracy improvement of risk prediction and countermeasure planning from the next time onward. Specifically, the system deploys a reward function calculation module and an experience replay buffer in reinforcement learning on a memory. The system inputs a series of response process data and a final result index to a model. The system inputs, as input data, for example, a vector representation of an executed countermeasure sequence, numerical data indicating a final system recovery time, and a floating-point number indicating a total damage amount. The system calculates a contribution degree of each response step based on these inputs. The system calculates a scalar reward value such that the shorter the recovery time, the higher the value, and the smaller the damage amount, the higher the value, using a reward function. The system generates an updated weight parameter of a policy network and a gradient vector of a value function as outputs of the model. The system outputs, as the weight parameter, for example, a floating-point number tensor of millions of dimensions. The system outputs, as the gradient vector, a numerical array indicating a correction direction and magnitude of each parameter. The system re-learns a neural network of an inference engine using these output results. The system applies the updated parameter to the next inference cycle. The system acquires a self-organization capability of the system against an unknown composite disaster by this autonomous learning loop. The system mathematically minimizes an inference error every time experience is accumulated. The system completely automates post-analysis and manual revision work by a human. The system exhibits an extremely high technical effect in use cases such as an autonomous operation system of a space probe and strategy update of high-frequency algorithmic trading.

Specific examples of a prompt sentence to be read by generative AI include “Generate a composite risk scenario in a data center when a typhoon approaches based on the following sensor data, SNS posts, weather information, and past failure cases, and evaluate an occurrence probability and a degree of impact of each”, “Automatically generate an action instruction for an on-site person in charge when emergency generator switching fails based on the following risk analysis result and past response cases”, “Analyze the following progress status data and list unaddressed risks and additional countermeasures”, and “Learn the following failure response history and update an optimal countermeasure pattern at the time of a typhoon disaster in the future”. Specifically, the system deploys a context optimization module that automates prompt engineering on a memory. The system inputs a natural language prompt character string and an accompanying context data tensor to a model. The system inputs, as input data, for example, the above instruction character string, a time-series array of sensor data, and an embedding vector of a past case. The system divides these inputs by a tokenizer, and truncates them to an optimal length according to a context window size of the model. The system generates an internal hidden state vector and a generated text token sequence as outputs of the model. The system outputs, as the hidden state vector, for example, an activation value tensor of thousands of dimensions in each layer. The system outputs, as the text token sequence, for example, an array of word IDs constituting a generated scenario or action instruction. The system transmits these output results to a decoder module. The system parses the token sequence into a human-readable character string or structured JSON data. The system stabilizes inference accuracy of a large language model by this vectorization of a prompt and optimization of a context. The system mathematically suppresses a hallucination phenomenon in which the model generates information different from facts. The system realizes maximum information extraction efficiency while minimizing consumption of calculation resources. The system exhibits an extremely high technical effect in use cases such as finding generation in a medical diagnosis support system and an automatic review system of a legal document.

In this way, the data center crisis management system of the present invention can maximize business continuity and safety of a data center by automating information collection, risk analysis, scenario generation, countermeasure planning, notification by related party, countermeasure execution, progress monitoring, and learning and evolution in an integrated manner with generative AI at the core even in a site where a plurality of abnormalities and external risks occur simultaneously. Specifically, the system deploys an orchestration engine of a containerized artificial intelligence model group based on a microservice architecture on a memory. The system continuously inputs a multimodal data stream flowing through the entire system to each module. The system inputs, as input data, for example, tens of thousands of sensor logs generated per second, asynchronous data from an external API, and a status response from a device. The system transfers these data between respective microservices using high-speed bus communication. The system generates an autonomous system control action and an optimized resource allocation map as outputs of the model. The system outputs, as the control action, for example, a direct control command of hardware or a dynamic reconfiguration command of a network. The system outputs, as the resource allocation map, for example, a numerical matrix indicating a dynamic allocation amount of a CPU or a memory for each container. The system maintains continuous monitoring and a feedback loop of the entire system using these output results. The system dramatically improves scalability of the entire system by this integrated architecture. The system realizes high fault tolerance in which the entire system does not stop even when some modules go down. The system enables fully autonomous infrastructure operation that does not require human intervention. The system exhibits an extremely high technical effect in use cases such as next-generation smart grid management and integrated control of a fully automated mega factory.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

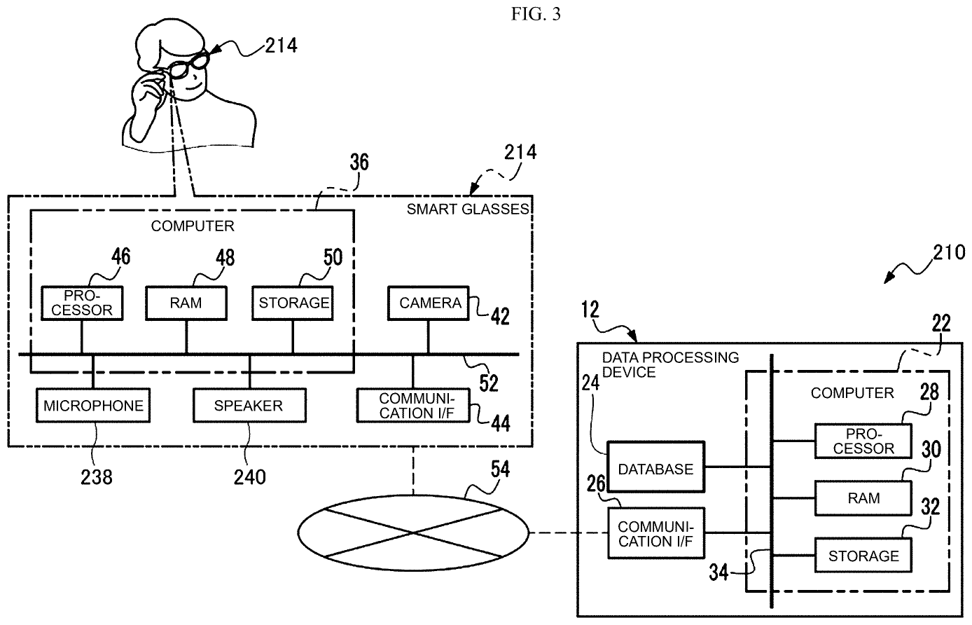

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

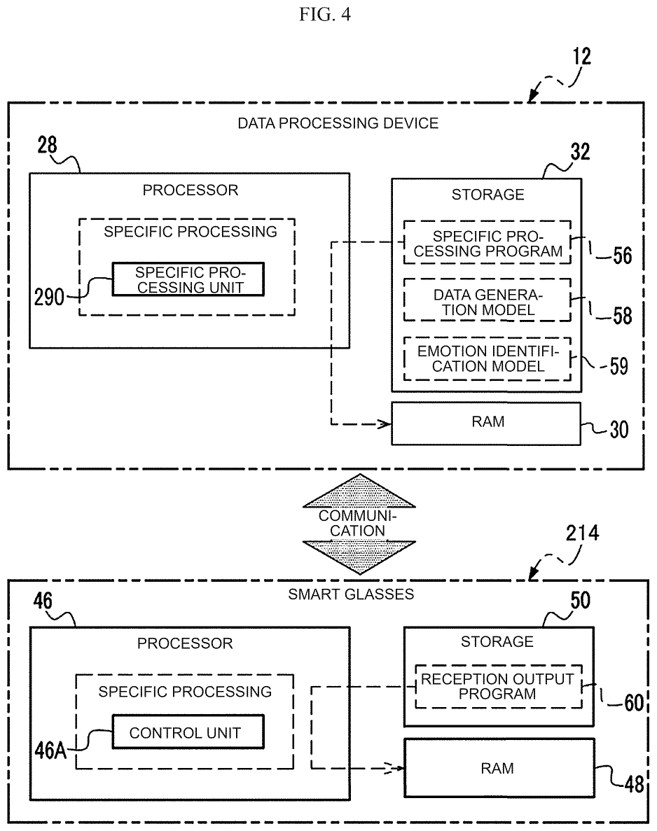

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

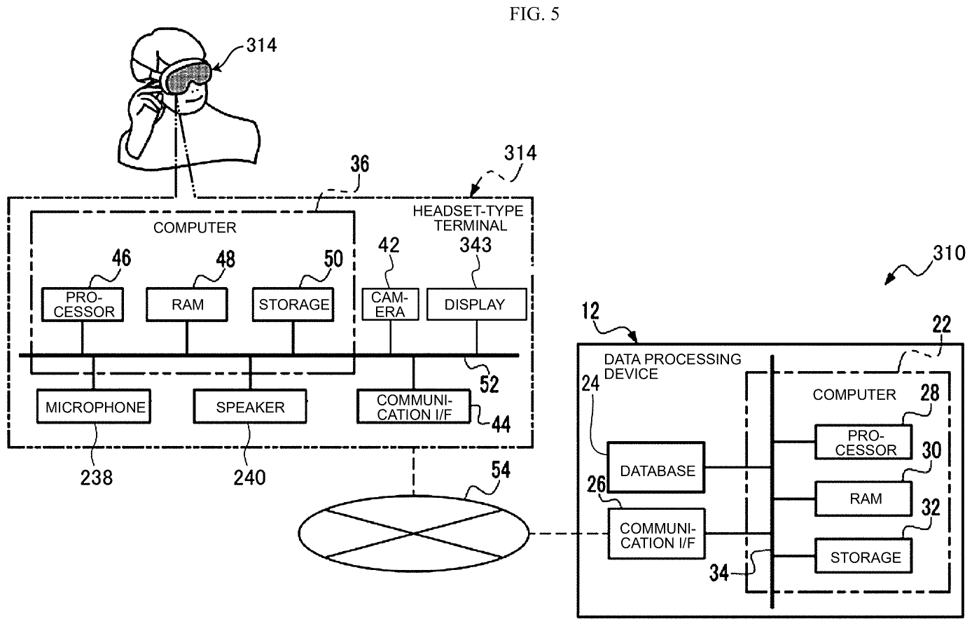

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

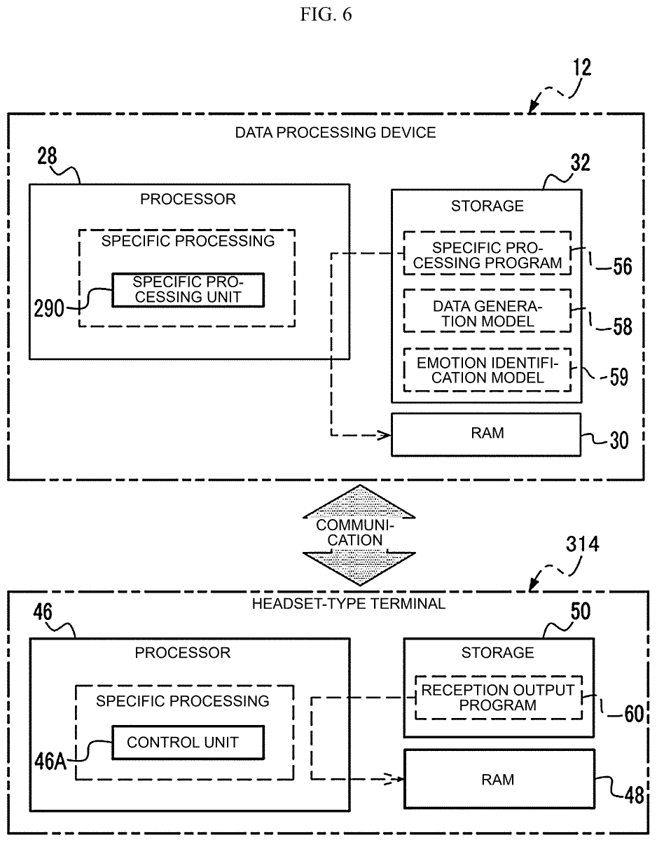

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

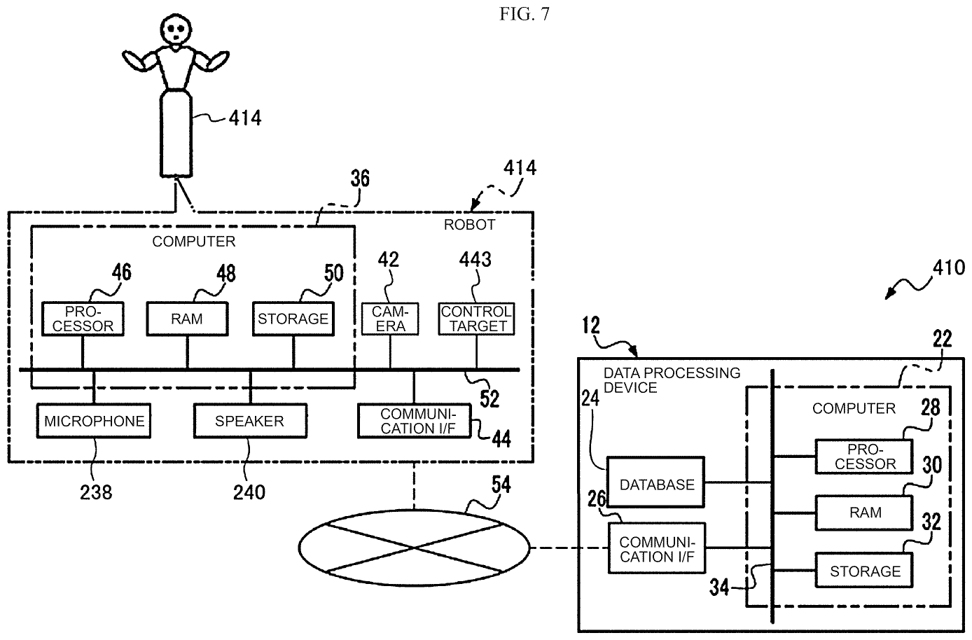

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

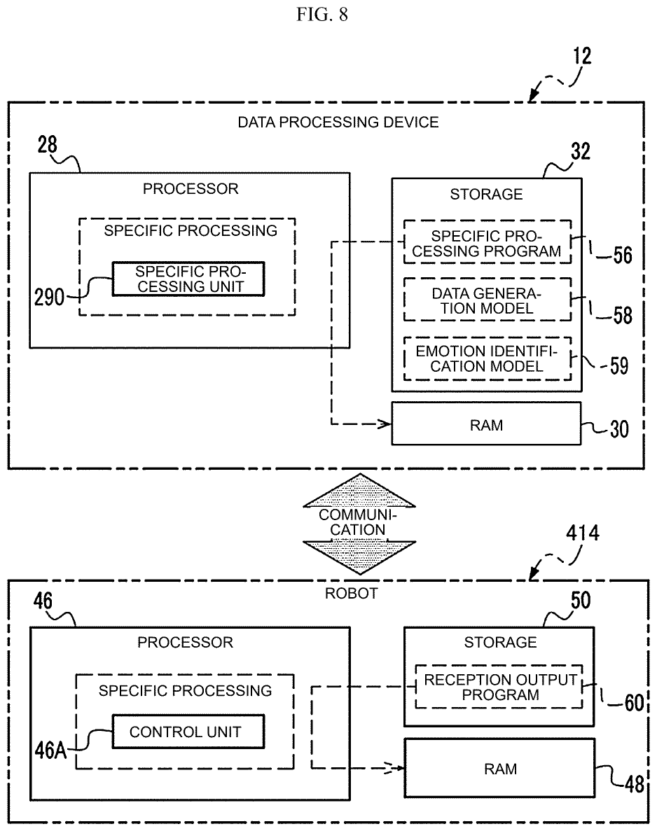

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

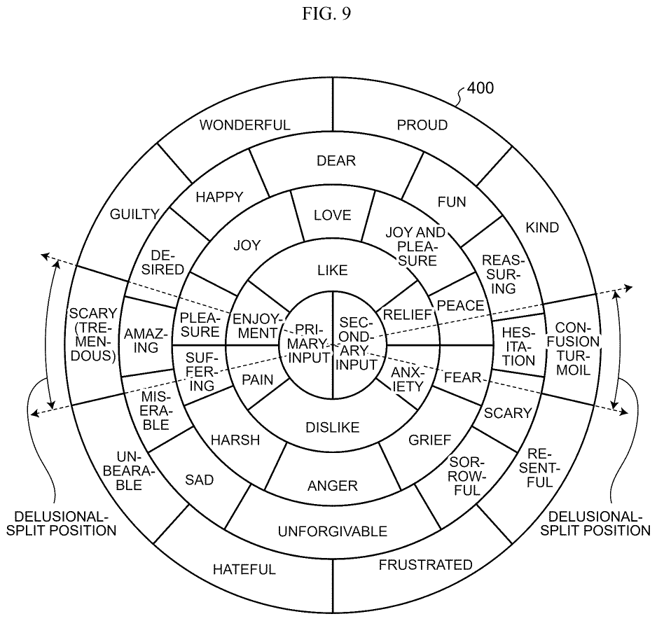

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

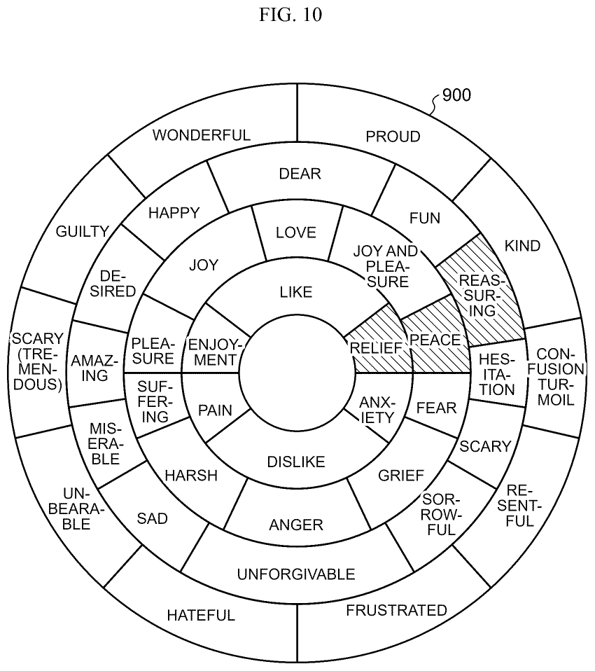

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A data center crisis management system comprising: a data collection unit; a risk analysis unit; and a countermeasure planning and execution unit, wherein the data collection unit is configured to automatically collect real-time data from various sensors and monitoring devices such as a power system, a cooling device, security monitoring, fire detection, human monitoring, and network monitoring in a data center, as well as data from diverse information sources such as external weather information, news, SNS, and disaster information, and classify and organize the collected data by attributes such as time series, occurrence location, equipment type, degree of abnormality, reliability, and information source; the risk analysis unit is configured to analyze a vast amount of data obtained from the data collection unit using generative AI by methods such as natural language processing, pattern recognition, abnormality detection, comparison with past failure cases, and correlation analysis with external data, extract risk factors such as power failure, cooling abnormality, fire, cyber attack, communication failure, human error, and external disaster, quantitatively predict a probability of risk occurrence and a degree of impact, and perform composite risk evaluation and prioritization when a plurality of risks occur simultaneously; and the countermeasure planning and execution unit is configured to automatically generate a plurality of optimal countermeasures according to a risk level and a type of risk while referring to past response cases, operation regulations, external guidelines, laws and regulations, contract conditions, and the like using generative AI based on a risk determination result by the risk analysis unit, automatically create reports and alert notifications whose contents are optimized for each related party such as for management, for an on-site person in charge, and for an operation department, and further automatically execute specific countermeasures such as automatic activation of a fire extinguishing system, activation of an emergency generator, blocking of an external connection, load distribution, and transmission of an instruction to the on-site person in charge in cooperation with a related equipment control system and network management system for an approved countermeasure plan.

### Supplementary Note 2

The data center crisis management system according to Supplementary Note 1, wherein using generative AI, the risk analysis unit analyzes real-time data from various sensors and monitoring devices such as a power system, a cooling device, security monitoring, fire detection, human monitoring, and network monitoring and diverse data such as external weather information, news, SNS, and disaster information acquired by the data collection unit by natural language processing, pattern recognition, abnormality detection, comparison with past failure cases, and correlation analysis with external data, and performs extraction of risk factors, prediction of a risk occurrence probability and a degree of impact, composite risk evaluation, and prioritization, and the countermeasure planning and execution unit automatically generates an optimal countermeasure according to a risk level and a type of risk, automatically creates reports and alert notifications optimized for each related party, and further automatically executes a countermeasure in cooperation with an equipment control system and a network management system based on an approved countermeasure plan.

### Supplementary Note 3

The data center crisis management system according to Supplementary Note 1, wherein using generative AI, the risk analysis unit analyzes a combination of past failure occurrence cases or an external database and currently acquired data, and generates a plurality of risk occurrence scenarios, and the countermeasure planning and execution unit automatically generates a plurality of optimal countermeasures for each of the scenarios, automatically creates reports and alert notifications whose contents are optimized for each related party such as for management, for an on-site person in charge, and for an operation department, and further automatically executes specific countermeasures such as automatic activation of a fire extinguishing system, activation of an emergency generator, blocking of an external connection, load distribution, and transmission of an instruction to the on-site person in charge in cooperation with an equipment control system and a network management system based on an approved countermeasure plan.

What is claimed is:

1. A system comprising:
circuitry configured to:
receive, via a communication interface coupled to a packet-switched network, multi-source input data comprising sensor data streams and event data streams from a plurality of data sources, and store the multi-source input data in a storage device;
classify the multi-source input data by temporal attributes and categorical attributes to generate tagged data records associated with classification labels and source identifiers;
analyze the tagged data records using a generative neural network model to extract event classification labels, generate probability scores and impact scores for each extracted event classification label, and compute composite severity scores by combining the probability scores and the impact scores;
generate, using the generative neural network model with reference to context data retrieved from a vector database storing historical case records and reference documents, response action sequences associated with priority scores corresponding to the composite severity scores;
generate structured notification data from the response action sequences, the structured notification data comprising content tailored to respective recipient classification parameters; and
transmit the structured notification data to terminal devices via the communication interface and issue execution commands to downstream processing systems via an application programming interface gateway.

2. The system according to claim 1, wherein the circuitry is configured to collect the multi-source input data using asynchronous communication protocols by polling a communication interface of each data source, and serialize heterogeneous data formats into structured data objects based on a unified data schema prior to classification.

3. The system according to claim 2, wherein the circuitry is configured to apply preprocessing operations comprising stop word removal, normalization of character codes, and interpolation of missing values to text data in the multi-source input data, and generate embedding vectors for the preprocessed text data using a transformer-based neural network model.

4. The system according to claim 3, wherein the circuitry is configured to store the embedding vectors in the vector database using high-dimensional similarity indexing, and retrieve candidate context records from the vector database based on cosine similarity scores between a query embedding vector and stored embedding vectors exceeding a similarity threshold.

5. The system according to claim 4, wherein the circuitry is configured to score each tagged data record against a plurality of attribute classification labels using a neural network model trained on labeled event records, register a corresponding classification label as an index entry in the vector database when a classification score exceeds a preset threshold value, and update an attribute index map in the storage device.

6. The system according to claim 1, wherein the circuitry is configured to apply token-level positional encoding to input token sequences prior to processing by the generative neural network model, and generate named entity recognition labels and sentiment polarity scores from the token sequences, the named entity recognition labels comprising event type identifiers and location identifiers.

7. The system according to claim 1, wherein the circuitry is configured to apply a one-dimensional convolutional neural network to a time-series sensor data array to compute reconstruction error scores by comparing predicted values against observed values, and generate an anomaly signal when a reconstruction error score exceeds an anomaly threshold parameter.

8. The system according to claim 7, wherein the circuitry is configured to apply a moving average filter to the time-series sensor data array prior to processing by the one-dimensional convolutional neural network, and accumulate reconstruction error scores over a sliding window to compute a trend deviation metric used in the composite severity score computation.

9. The system according to claim 7, wherein the circuitry is configured to apply a two-dimensional convolutional neural network to image tensor data received from imaging devices to generate bounding box coordinate arrays and class probability scores, and incorporate the class probability scores into the composite severity score computation when a class probability score exceeds a detection threshold parameter.

10. The system according to claim 1, wherein the circuitry is configured to apply a graph neural network to a node feature vector representing a current event state and an edge connection matrix extracted from historical case records to execute message passing operations between adjacent nodes, and generate occurrence probability scores and impact degree scores for a plurality of event scenario nodes, and sort the event scenario nodes in descending order by a product of the occurrence probability scores and the impact degree scores.

11. The system according to claim 10, wherein the circuitry is configured to generate the response action sequences by applying a retrieval-augmented generation process comprising embedding a risk type vector and the composite severity scores into a prompt template, retrieving context text from the vector database, and generating, by autoregressive decoding, action step text sequences each associated with an execution priority score.

12. The system according to claim 11, wherein the circuitry is configured to convert the action step text sequences into structured data objects comprising a target system identifier, a function call identifier, and a parameter group, and filter the structured data objects according to an authority level parameter associated with recipient classification parameters prior to transmission.

13. The system according to claim 12, wherein the circuitry is configured to transmit the structured data objects as execution commands to downstream processing systems via the application programming interface gateway, receive execution status codes and execution log data from the downstream processing systems, and store the execution status codes and execution log data in a time-series database in the storage device.

14. The system according to claim 13, wherein the circuitry is configured to monitor the execution status codes received from the downstream processing systems, and schedule a retry process using an exponential backoff algorithm when a received execution status code indicates an error condition.

15. The system according to claim 14, wherein the circuitry is configured to recompute the composite severity scores based on updated multi-source input data received after execution of the response action sequences, and generate additional response action sequences when the recomputed composite severity scores exceed a re-evaluation threshold parameter.

16. The system according to claim 1, wherein the circuitry is configured to deploy a lightweight inference model on a terminal device to perform feature extraction on raw sensor data and generate compressed vector data and initial classification labels, transmit the compressed vector data to the system via the communication interface, and reduce data transfer volume by substituting compressed vector data for raw sensor data in the multi-source input data.

17. The system according to claim 1, wherein the classified event classification labels comprise crisis event types associated with infrastructure monitoring data, external environmental data, and network security monitoring data, and the response action sequences correspond to crisis response procedures for the respective crisis event types.

18. A system comprising:
circuitry configured to:
receive, via a communication interface coupled to a packet-switched network, multi-source input data comprising time-series sensor data arrays, image tensor data, and text event data from a plurality of sensor devices and external data service interfaces;
classify the multi-source input data by temporal attributes and categorical attributes using a transformer-based neural network model to generate tagged data records associated with classification scores;
extract event classification labels and sentiment polarity scores from the tagged data records using a large language model comprising a self-attention mechanism, and generate probability scores and impact degree scores for each event classification label;
compute composite severity scores by applying a graph neural network to a node feature vector representing current event states and an edge connection matrix derived from historical case records stored in a vector database;
generate response action sequences by applying a retrieval-augmented generation process to the composite severity scores with reference to context data retrieved from the vector database; and
transmit structured notification data to terminal devices and issue execution commands to downstream processing systems via the communication interface.

19. The system according to claim 18, wherein the circuitry is configured to monitor execution status codes received from the downstream processing systems after issuing the execution commands, and generate updated response action sequences when a received execution status code indicates an error condition or when recomputed composite severity scores based on updated multi-source input data exceed a re-evaluation threshold parameter.

20. A method comprising:
receiving, via a communication interface coupled to a packet-switched network, multi-source input data comprising sensor data streams and event data streams from a plurality of data sources, and storing the multi-source input data in a storage device;
classifying the multi-source input data by temporal attributes and categorical attributes to generate tagged data records associated with classification labels and source identifiers;
analyzing the tagged data records using a generative neural network model to extract event classification labels, generate probability scores and impact scores for each extracted event classification label, and compute composite severity scores by combining the probability scores and the impact scores;
generating, using the generative neural network model with reference to context data retrieved from a vector database storing historical case records and reference documents, response action sequences associated with priority scores corresponding to the composite severity scores;
generating structured notification data from the response action sequences, the structured notification data comprising content tailored to respective recipient classification parameters; and
transmitting the structured notification data to terminal devices via the communication interface and issuing execution commands to downstream processing systems via an application programming interface gateway.
